(19) United States
(12) Patent Application Publication
(10) Pub. No.: US 2023/0171769 A1
(43) Pub. Date: Jun. 1, 2023

(54) METHOD AND APPARATUS FOR TRANSMITTING UPLINK DATA AND COMMUNICATION SYSTEM

(71) Applicant: FUJITSU LIMITED, Kawasaki-shi (JP)

(72) Inventors: Zhe CHEN, Beijing (CN); Lei ZHANG, Beijing (CN); Jian ZHANG, Beijing (CN); Qinyan JIANG, Beijing (CN)

(73) Assignee: FUJITSU LIMITED, Kawasaki-shi (JP)

(21) Appl. No.: 18/103,611

(22) Filed: Jan. 31, 2023

Related U.S. Application Data
(63) Continuation of application No. PCT/CN2020/107573, filed on Aug. 6, 2020.

(51) Int. Cl. H04W 72/1268; H04L 1/08

(52) U.S. Cl. CPC H04W 72/1268; H04L 1/08

(57) ABSTRACT

A method and apparatus for transmitting uplink data and a communication system. The method includes a terminal equipment transmits uplink data in a manner of PUSCH repetition type B, at least one transmission occasion of the uplink data being associated with two TRPs, wherein an RV of the at least one transmission occasion of the uplink data is derived according to the two TRPs. When uplink data are transmitted with multiple TRPs, the uplink data are transmitted according to corresponding RVs, thereby enhancing reliability of transmission the uplink data, or, the uplink data are transmitted according to a corresponding frequency hopping pattern, so that transmission of the uplink data may make full use of frequency diversity gain, thereby improving reliability accordingly.

### CROSS-REFERENCE TO RELATED APPLICATION

This application is a continuation application of International Application PCT/CN2020/107573 filed on Aug. 6, 2020 and designated the U.S., the entire contents of which are incorporated herein by reference.

### FIELD

This disclosure relates to the field of communications.

### BACKGROUND

In order to meet requirements of URLLC (ultra reliable low latency communications) services on both high reliability and low latency, NR Rel-16 (New radio Release 16) introduces a corresponding uplink data transmission mechanism, which supports more flexible uplink data transmission to ensure transmitting uplink data in a low latency manner.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that NR (New Radio) supports a carrier frequency up to 52.6 GHz. When the carrier frequency is relatively high, a high-frequency signal is easily blocked by obstacles due to its poor diffraction ability. When a transmission path is blocked, corresponding transmission channel quality is seriously degraded, thereby resulting in reduction of reliability of a transmission signal and/or increase of transmission delay. This is very unfavorable for URLLC services. In particular, when the signal blockage is serious to some extent, the URLLC services in progress may be forced to interrupt or fail. This is because by using an existing uplink scheduling mechanism, it takes tens of milliseconds for a terminal equipment to recover a communication link at the fastest speed, while the communication delay requirements of URLLC is generally far less than tens of milliseconds. After a link failure, URLLC service packets in transmission fail because of time expiration before they can wait for the communication link to respond.

In order to reduce the impact of the instability of the high-frequency transmission channel on the uplink data transmission, a feasible way is to enable the uplink data to be transmitted in a spatial diversity manner. That is, at a UE side, the same data can reach a base station via different spatial domain paths or different TRPs (transmission and reception points). In this way, when one path is blocked, other paths can still work, thereby ensuring high reliability of the uplink data and effectively reducing the impact of channel instability on transmission latency.

On the other hand, in order to improve merge gains, data transmission usually corresponds to a specific RV (redundancy version). However, when data are transmitted via multiple TRPs, there exists no method to indicate a relation between corresponding data transmission and the redundancy version, especially a relation between data transmission in a manner of a PUSCH repetition type A or a PUSCH repetition type B and the redundancy version.

On the other hand, for uplink data transmission, performing frequency hopping when transmitting uplink data may effectively use frequency diversity gains to improve system performance. However, there exists currently no way to realize frequency hopping of uplink data in a scenario of multiple-TRP, especially in a scenario where uplink data are transmitted to different TRPs in a manner of a PUSCH repetition type A or a PUSCH repetition type B.

In order to solve at least one of the above problems or other similar problems, embodiments of this disclosure provide a method and apparatus for transmitting uplink data and a communication system, so that in performing multiple-TRP transmission, uplink data may be transmitted according to a corresponding RV, thereby enhancing reliability of uplink data transmission, or may be transmitted according to a corresponding frequency hopping pattern, so that the uplink data transmission may make full use of frequency diversity gain, thereby improving reliability accordingly.

According to an aspect of the embodiments of this disclosure, there is provided a method for transmitting uplink data, the method including:

a terminal equipment transmits uplink data in a manner of PUSCH repetition type B, at least one transmission occasion of the uplink data being associated with two TRPs;

wherein an RV of the at least one transmission occasion of the uplink data is derived according to the two TRPs.

According to another aspect of the embodiments of this disclosure, there is provided a method for transmitting uplink data, the method including:

a terminal equipment transmits uplink data in a manner of PUSCH repetition type A, at least one transmission occasion of the uplink data being associated with two TRPs;

wherein an RV of the at least one transmission occasion of the uplink data is derived according to the two TRPs.

According to a further aspect of the embodiments of this disclosure, there is provided a method for transmitting uplink data, the method including:

a terminal equipment transmits uplink data, at least one transmission occasion of the uplink data being associated with two TRPs, the terminal equipment performs frequency hopping on transmission of the uplink data

according to a transmission occasion in the at least one transmission occasion of the uplink data associated with a TRP in the two TRPs.

According to still another aspect of the embodiments of this disclosure, there is provided a method for indicating uplink data transmission, the method including:

a network device transmits indication information to a terminal equipment, the indication information indicating an RV of a transmission occasion of uplink data associated with a first TRP in two TRPs, an RV of at least one transmission occasion of the uplink data being derived according to the two TRPs.

According to an aspect of the embodiments of this disclosure, there is provided a method for indicating uplink data transmission, the method including:

a network device transmits indication information to a terminal equipment, the indication information indicating a frequency hopping pattern, the terminal equipment transmitting uplink data according to the frequency hopping pattern;

wherein at least one transmission occasion of the uplink data is associated with two TRPs, and the terminal equipment performs frequency hopping on transmission of the uplink data according to a transmission occasion in the at least one transmission occasion of the uplink data associated with a TRP in the two TRPs.

According to an aspect of the embodiments of this disclosure, there is provided an apparatus for transmitting uplink data, the apparatus including:

a transmitting unit configured to transmit uplink data in a manner of PUSCH repetition type B, at least one transmission occasion of the uplink data being associated with two TRPs;

wherein an RV of the at least one transmission occasion of the uplink data is derived according to the two TRPs.

According to another aspect of the embodiments of this disclosure, there is provided an apparatus for transmitting uplink data, the apparatus including:

a transmitting unit configured to transmit uplink data in a manner of PUSCH repetition type A, at least one transmission occasion of the uplink data being associated with two TRPs;

wherein an RV of at least one transmission occasion of the uplink data is derived according to the two TRPs.

According to a further aspect of the embodiments of this disclosure, there is provided an apparatus for transmitting uplink data, the apparatus including:

a transmitting unit configured to transmit uplink data, at least one transmission occasion of the uplink data being associated with two TRPs,

the terminal equipment performing frequency hopping on transmission of the uplink data according to a transmission occasion in the at least one transmission occasion of the uplink data associated with a TRP in the two TRPs.

According to still another aspect of the embodiments of this disclosure, there is provided an apparatus for indicating uplink data transmission, the apparatus including:

a transmitting unit configured to transmit indication information to a terminal equipment, the indication information indicating an RV of a transmission occasion of uplink data associated with a first TRP in two TRPs, an RV of at least one transmission occasion of the uplink data being derived according to the two TRPs.

According to an aspect of the embodiments of this disclosure, there is provided an apparatus for indicating uplink data transmission, the apparatus including:

a transmitting unit configured to transmit indication information to a terminal equipment, the indication information indicating a frequency hopping pattern, the terminal equipment transmitting uplink data according to the frequency hopping pattern;

wherein at least one transmission occasion of the uplink data is associated with two TRPs, and the terminal equipment performs frequency hopping on transmission of the uplink data according to a transmission occasion in the at least one transmission occasion of the uplink data associated with a TRP in the two TRPs.

An advantage of the embodiments of this disclosure exists in that according to the embodiments of this disclosure, in performing multiple-TRP transmission, uplink data may be transmitted according to a corresponding RV, thereby enhancing reliability of uplink data transmission, or may be transmitted according to a corresponding frequency hopping pattern, so that the uplink data transmission may make full use of frequency diversity gain, thereby improving reliability accordingly.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments.

Moreover, in the drawings, like reference numerals designate corresponding parts within the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of an example of a dynamically scheduled PUSCH;

FIG. 2 is a schematic diagram of an example of a configured grant PUSCH;

FIG. 3 is a schematic diagram of an example of a dynamically scheduled PUSCH;

FIG. 4 is a schematic diagram of an example of a configured grant PUSCH;

FIG. 5 is a schematic diagram of the method for transmitting uplink data of an embodiment of this disclosure;

FIG. 6 is a schematic diagram of an example of a mapping relation between a dynamically scheduled PUSCH and an RV sequence;

FIG. 7 is a schematic diagram of another example of the mapping relation between a dynamically scheduled PUSCH and an RV sequence;

FIG. 8 is a schematic diagram of a further example of the mapping relation between a dynamically scheduled PUSCH and an RV sequence;

FIG. 9 is a schematic diagram of an example of a mapping relation between a configured grant PUSCH and an RV sequence;

FIG. 10 is a schematic diagram of another example of the mapping relation between a configured grant PUSCH and an RV sequence;

FIG. 11 is a schematic diagram of a further example of the mapping relation between a configured grant PUSCH and an RV sequence;

FIG. 12 is a schematic diagram of the method for transmitting uplink data of an embodiment of this disclosure;

FIG. 13 is a schematic diagram of an example of a mapping relation between a dynamically scheduled PUSCH and an RV sequence;

FIG. 14 is a schematic diagram of an example of the mapping relation between a configured grant PUSCH and an RV sequence;

FIG. 15 is a schematic diagram of another example of the mapping relation between a configured grant PUSCH and an RV sequence;

FIG. 16 is a schematic diagram of a further example of the mapping relation between a configured grant PUSCH and an RV sequence;

FIG. 17 is a schematic diagram of the method for transmitting uplink data of an embodiment of this disclosure;

FIG. 18 is a schematic diagram of an example of a mapping relation between a dynamically scheduled or configured grant PUSCH and a frequency hopping pattern;

FIG. 19 is a schematic diagram of another example of the mapping relation between a dynamically scheduled or configured grant PUSCH and a frequency hopping pattern;

FIG. 20 is a schematic diagram of a further example of the mapping relation between a dynamically scheduled or configured grant PUSCH and a frequency hopping pattern;

FIG. 21 is a schematic diagram of still another example of the mapping relation between a dynamically scheduled or configured grant PUSCH and a frequency hopping pattern;

FIG. 22 is a schematic diagram of an example of the mapping relation between a dynamically scheduled or configured grant PUSCH and a frequency hopping pattern;

FIG. 23 is a schematic diagram of another example of the mapping relation between a dynamically scheduled or configured grant PUSCH and a frequency hopping pattern;

FIG. 24 is a schematic diagram of the apparatus for indicating uplink data transmission of an embodiment of this disclosure;

FIG. 25 is a schematic diagram of the method for indicating uplink data transmission of an embodiment of this disclosure;

FIG. 26 is a schematic diagram of the apparatus for transmitting uplink data of an embodiment of this disclosure;

FIG. 27 is a schematic diagram of the apparatus for transmitting uplink data of an embodiment of this disclosure;

FIG. 28 is a schematic diagram of the apparatus for transmitting uplink data of an embodiment of this disclosure;

FIG. 29 is a schematic diagram of the apparatus for indicating uplink data transmission of an embodiment of this disclosure;

FIG. 30 is another schematic diagram of the apparatus for indicating uplink data transmission of an embodiment of this disclosure;

FIG. 31 is a schematic diagram of the communication system of an embodiment of this disclosure;

FIG. 32 is a schematic diagram of the terminal equipment of an embodiment of this disclosure; and

FIG. 33 is a schematic diagram of the network device of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, an Machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In order to make the embodiments of this disclosure clear and understandable, some concepts and definitions involved in the embodiments of this disclosure are explained below.

The PUSCH repetition Type A is described below.

In the embodiments of this disclosure, PUSCH repetition Type A is a slot-based uplink data transmission manner. A PUSCH (physical uplink shared channel) transmitted in PUSCH repetition Type A corresponds to one or more repetitions or transmission occasions, which are marked as repetition #1, repetition #2, . . . , repetition #m; where, m=1,2,3 . . . , K, K is the number of repetitions of the PUSCH. If K>1, there exists a repetition for each slot in K consecutive slots, and these repetitions have identical time domain/symbol allocation modes. In addition, these repetitions correspond to identical TBs (transmission blocks). Specifically, the PUSCH may be indicated by the following parameters:

a starting slot of the PUSCH (marked as Ks);

a time domain starting symbol of the PUSCH (marked as S);

a time domain length of each repetition (marked as L), this length being in units of symbol; and

the number of repetitions (K); for example, the above number of repetitions is 1,2,4,7,16, and the number of repetitions may also be 2,4,8; however, this disclosure is not limited thereto, and the number of repetitions may also be other positive integers.

It should be noted that the above S and L may be indicated separately, or may be indicated jointly by a start and length indicator (SLIV).

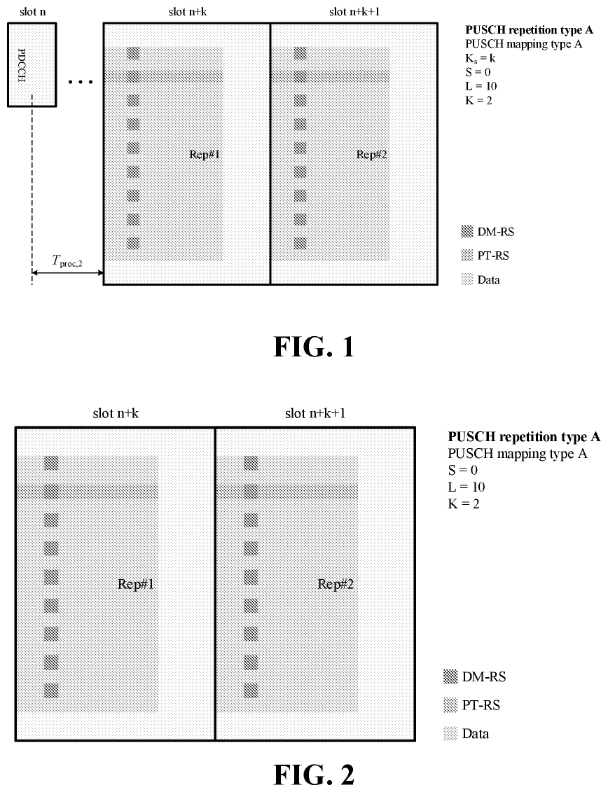

FIG. 1 is a schematic diagram of an example of a dynamically scheduled PUSCH. As shown in FIG. 1, when a UE receives a PUSCH transmission indication (such as a PDCCH), it transmits a corresponding PUSCH, wherein, specific parameters are:

Ks=k; for example, k may be 0,1,2 . . . .

S=0;

K=2.

In the example in FIG. 1, a time-domain resource mapping type of the PUSCH (PUSCH mapping type) is PUSCH mapping type A, in which, a DM-RS (demodulation reference signal) starts from a third symbol of each slot, and a corresponding phase-tracking reference signal (PT-RS) is configured. As K=2, a first repetition or a first transmission occasion of the PUSCH is in a slot n+k, and a second repetition or a second transmission occasion of the PUSCH is in a slot n+k+1.

FIG. 2 is a schematic diagram of an example of a configured grant PUSCH. As shown in FIG. 2, a UE determines that a PUSCH may be transmitted in slot n+k (that is, there is a PUSCH transmission occasion starting from slot n+k) according to CG configuration corresponding to the PUSCH and/or an indication of activation DCI related to the PUSCH. Corresponding other parameters are:

S=0;

L=10;

K=2;

In the example in FIG. 2, a PUSCH time-domain resource mapping type of the PUSCH (PUSCH mapping type) is PUSCH mapping type A, in which, a DM-RS starts from a third symbol of each slot, and a corresponding PT-RS is configured. As K=2, a first repetition or a first transmission occasion of the PUSCH is in slot n+k, and a second repetition or a second transmission occasion of the PUSCH is in slot n+k+1.

The PUSCH repetition Type B is explained below.

In the embodiments of this disclosure, the PUSCH repetition Type B is an uplink data transmission manner with low-latency. A PUSCH transmitted in a PUSCH repetition type B manner corresponds to one or more nominal repetitions or corresponds to transmission occasions of one or more nominal repetitions, which are marked as nominal repetition #1, nominal repetition #2, . . . , nominal repetition #n; where, n=1, 2, 3 N, and N is the number of nominal repetitions of the PUSCH. Specifically, the PUSCH may be indicated by the following parameters:

a starting slot of the PUSCH (marked as Ks);

a time domain starting symbol of the PUSCH (marked as S);

a time domain starting point, a time domain ending point and a time domain length for PUSCH nominal repetition #n, a slot corresponding to the time domain starting point being

$${K}_{s} + ⌊ \frac{S + n L}{{N}_{s y m b}^{s l o t}} ⌋ ,$$

a symbol corresponding to the time domain starting point being mod(S+nL, N_{symb}^{slot}), a slot corresponding to the time domain ending point being

$${K}_{s} + ⌊ \frac{S + ( n + 1 ) L - 1}{{N}_{s y m b}^{slot}} ⌋ ,$$

a symbol corresponding to the time domain ending point being mod(S+(n+1)L−1, N_{symb}^{slot}), and the time domain length (L) being in units of symbols; in the above formulae, N_{symb}^{slot} refers to a symbol corresponding to a slot; and

the number (N) of nominal repetitions; for example, the above number of repetitions is 1,2,4,7,12,16; however, this disclosure is not limited thereto, and the number of repetitions may also be other positive integers.

After the UE determines time domain resources corresponding to the nominal repetitions according to the above parameters, it needs to further determine corresponding actual repetitions according to a slot boundary and invalid symbol (s). A method for determination is: in a slot, if the number of potentially valid symbols corresponding to a nominal repetition that exclude invalid symbols is greater than zero, the nominal repetitions consist of one or more actual repetitions, wherein each actual repetition consists of all the continuous potential valid symbols.

It should be noted that invalid symbols include symbols indicated as downlink by higher layer signaling. Here, the higher layer signaling may be a cell-dedicated uplink/downlink TDD (time division duplexing) configuration, such as tdd-UL-DL-ConfigurationCommon, and the higher layer signaling may also be a UE-dedicated uplink/downlink TDD configuration, such as tdd-UL-DL-ConfigurationDedicated.

Alternatively, the invalid symbol may also include a symbol corresponding to an invalid symbol pattern indicated by higher layer signaling. For a type 2 configured grant or dynamic scheduled, whether the invalid symbol pattern is effective may be determined according to an invalid symbol pattern indicator field of DCI. For example, when this field is set to be 1, a corresponding invalid symbol pattern is deemed as being valid; and when this field is set to be 0, a corresponding invalid symbol pattern is deemed as being invalid.

In addition, when L is not equal to 1 and a length of an actual repetition is of 1 symbol, the actual repetition will be omitted or will not be transmitted. When an actual repetition conflicts with a slot format, for example, when a flexible symbol is interpreted/indicated as a DL symbol according to an indication of the DCI, the actual repetition will be omitted or will not be transmitted.

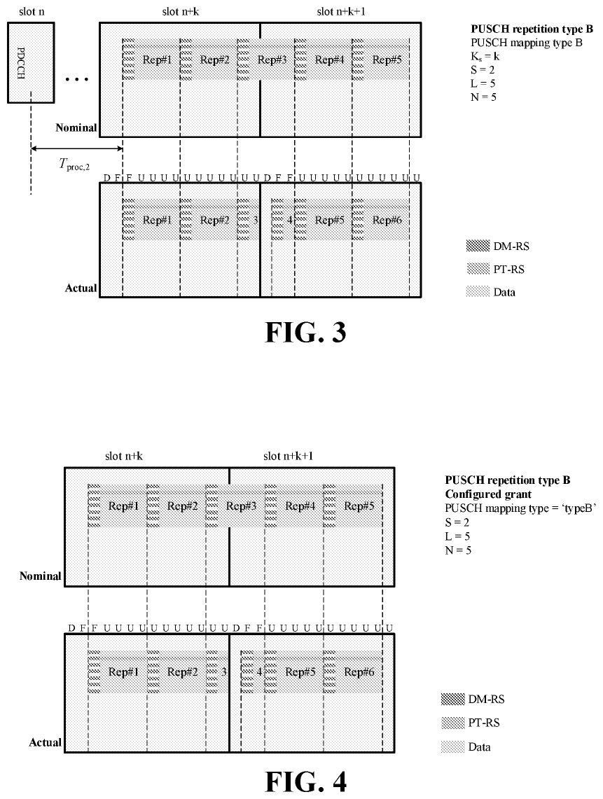

FIG. 3 is a schematic diagram of an example of a dynamically scheduled PUSCH. As shown in FIG. 3, after the UE receives a PUSCH transmission indication (such as a PDCCH), it transmits a corresponding PUSCH after at least T_{proc,2}; where, T_{proc,2} refers to a UE PUSCH preparation procedure time; in addition, other parameters are:

Ks=k; for example, k may be 0,1,2 . . . .

S=2;

L=5;

N=5.

In this example, a slot format of each symbol is configured by the higher layer signaling; and as shown in FIG. 3, D denotes a downlink symbol, U denotes an uplink symbol, and F denotes a flexible symbol. In addition, a PUSCH time domain resource mapping type (PUSCH mapping type) is PUSCH mapping type B, in which, the DM-RS starts from a first symbol of each actual repetition, and a PT-RS is configured.

In this example, the above PUSCH corresponds to 5 normal repetitions and 6 actual repetitions respectively; or, in other words, the above PUSCH corresponds to transmission occasions of 5 nominal repetitions, or the above PUSCH corresponds to transmission occasions of 6 actual repetitions. This is because nominal repetition #3 crosses the slot boundary, and a first symbol of slot n+k+1 is configured as a DL symbol, i.e. an invalid symbol, and according to the above rules, this symbol is not included in the actual repetitions. Therefore, the nominal repetition #3 is divided into two parts (actual repetition #3 and actual repetition #4), which occupy two consecutive symbols respectively.

FIG. 4 is a schematic diagram of an example of a configured grant PUSCH. As shown in FIG. 4, the UE determines that a PUSCH may be transmitted starting from slot n+k (that is, there is a PUSCH transmission occasion starting from slot n+k) according to CG configuration corresponding to the PUSCH and/or an indication of activation DCI related to the PUSCH.

Corresponding other parameters are:

S=2;

L=5;

N=5.

In this example, a slot format of each symbol is configured by the higher layer signaling; and as shown in FIG. 4, D denotes a downlink symbol, U denotes an uplink symbol, and F denotes a flexible symbol. In addition, a DM-RS starts from a first symbol of each actual repetition and a PT-RS is configured.

In this example, the above PUSCH transmission corresponds to 5 normal repetitions and 6 actual repetitions respectively; or, in other words, the above PUSCH corresponds to transmission occasions of 5 nominal repetitions, or the above PUSCH corresponds to transmission occasions of 6 actual repetitions. This is because nominal repetition #3 crosses the slot boundary, and a first symbol of slot n+k+1 is configured as a DL symbol, i.e. an invalid symbol, and according to the above rules, this symbol is not included in the actual repetitions. Therefore, the nominal repetition #3 is divided into two parts (actual repetition #3 and actual repetition #4), which occupy two consecutive symbols respectively.

This application provides multiple-TRP transmission schemes for two different methods for transmitting uplink data (PUSCH repetition Type A and PUSCH repetition Type B).

Various embodiments of this disclosure shall be described below with reference to the accompanying drawings. These embodiments are illustrative only and are not intended to limit this disclosure.

### Embodiment of a First Aspect

The embodiment of this disclosure provides a method for transmitting uplink data, which shall be described from a terminal equipment side. The method of the embodiment of this disclosure is applicable to uplink data (PUSCHs) transmitted in a manner of PUSCH repetition type B, and shall be described by taking the scenario of the dynamically scheduled PUSCH shown in FIG. 3 and the scenario of the configured grant PUSCH shown in FIG. 4 as examples.

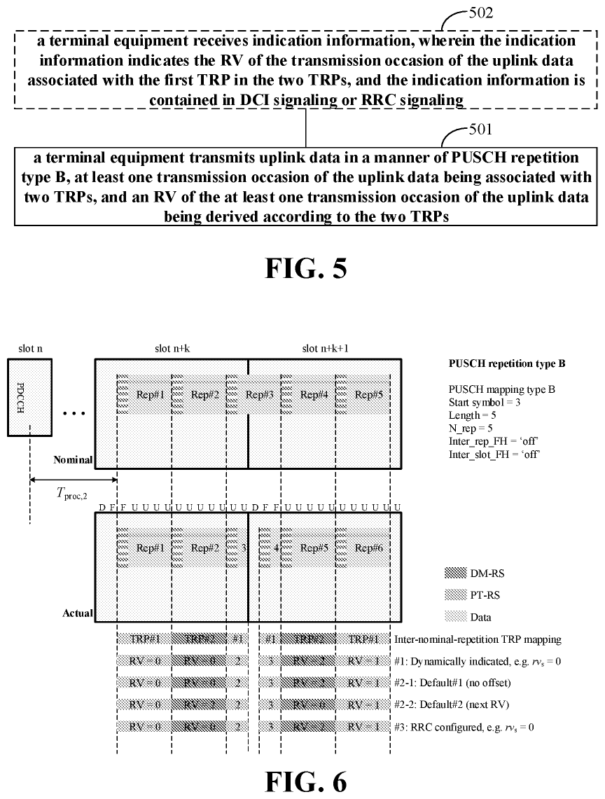

FIG. 5 is a schematic diagram of the method for transmitting uplink data of the embodiment of this disclosure. Referring to FIG. 5, the method includes:

501: a terminal equipment transmits uplink data in a manner of PUSCH repetition type B, at least one transmission occasion of the uplink data being associated with two TRPs, and an RV of the at least one transmission occasion of the uplink data being derived according to the two TRPs.

In the embodiment of this disclosure, the transmission occasion may be understood as a time-frequency resource, or may be understood as a repetition, and these concepts may be equivalent to each other.

In the embodiment of this disclosure, the transmission occasion is equivalent to an actual repetition, and is also equivalent to a transmission occasion of an actual repetition; and in addition, a transmission occasion of a nominal repetition is equivalent to the nominal repetition, and is also equivalent to a transmission occasion of an actual repetition corresponding to a nominal repetition.

According to the method of the embodiment of this disclosure, it may be ensured that in case of blockage, even if only a part of TRPs may operate, compared with a case where the RV is unrelated to TRPs, there may have higher combined gains. This is because this method enables an RV of a transmission occasion of the above uplink data to be adjusted according to information on the TRPs, that is, in a case where TRPs corresponding to the transmission occasions of the uplink data are different, or when a probability that corresponding TRPs are blocked changes, an RV of each transmission occasion may be optimally determined according to the information on the TRPs, thereby improving performances of the system.

In some embodiments, that the RV of the at least one transmission occasion of uplink data is derived according to the above two TRPs refers to that,

an RV of a transmission occasion of an actual repetition associated with a first TRP in the above two TRPs in the at least one transmission occasion of the uplink data is derived from a time domain order of the actual repetition, and an RV of a transmission occasion of an actual repetition associated with a second TRP in the above two TRPs in the at least one transmission occasion of the uplink data is derived from a time domain order of the actual repetition. That is, the RV sequence is cyclically mapped to the transmission occasions of the actual repetitions of the PUSCH.

In some embodiments, that the RV of the at least one transmission occasion of uplink data is derived according to the above two TRPs refers to that,

an RV of a transmission occasion of a nominal repetition associated with a first TRP in the above two TRPs in the at least one transmission occasion of the uplink data is derived from a time domain order of the nominal repetition, and an RV of a transmission occasion of a nominal repetition associated with a second TRP in the above two TRPs in the at least one transmission occasion of the uplink data is derived from a time domain order of the nominal repetition. That is, the RV sequence is cyclically mapped to the transmission occasions of the nominal repetitions of the PUSCH.

FIG. 6 is a schematic diagram of an example of a mapping relation between a dynamically scheduled PUSCH and an RV sequence. As shown in FIG. 6, the mapping relation between the PUSCH and the two TRPs is inter-nominal-repetition TRP mapping, that is, the PUSCH is cyclically mapped (correlated) with the two TRPs in units of transmission occasions of the nominal repetitions, while the RV sequence ({0,2,3,1} in FIG. 6) is cyclically mapped to the transmission occasions of the actual repetitions of the PUSCH, that is, a mapping manner of the RV sequence is actual-repetition-based RV mapping.

In the example in FIG. 6, an RV sequence corresponding to TRP #1 is identical to an RV sequence corresponding to TRP #2, which are both {0,2,3,1}. In addition, a difference (offset) between an RV of an n-th actual repetition (or a transmission occasion of an actual repetition) of the PUSCH associated with TRP #1 and an RV of an n-th actual repetition (or a transmission occasion of an actual repetition) of the PUSCH associated with TRP #2 is rvₛ; where, n is a natural number. And furthermore, the RVs are cyclically mapped according to actual repetitions or transmission occasions of actual repetitions associated with each TRP, which are collectively referred to as “transmission occasions of actual repetitions” in the following description for the convenience of explanation.

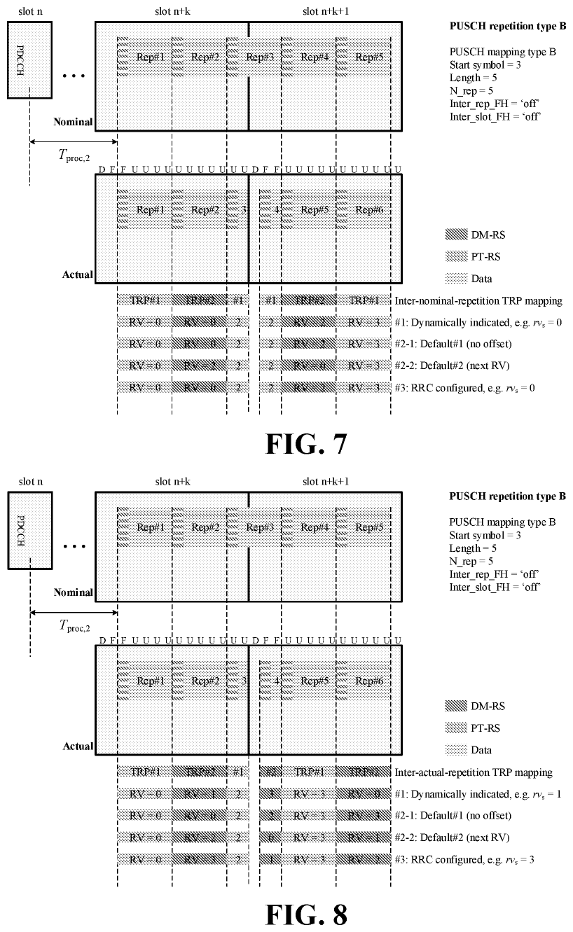

FIG. 7 is a schematic diagram of another example of the mapping relation between a dynamically scheduled PUSCH and an RV sequence. As shown in FIG. 7, the mapping relation between the PUSCH and the two TRPs is identical to that in FIG. 6, which is referred to in brief as inter-nominal-repetition TRP mapping, that is, the PUSCH is cyclically mapped (correlated) with the two TRPs in units of transmission occasions of the nominal repetitions, while the RV sequence ({0,2,3,1} in FIG. 7) is cyclically mapped to the transmission occasions of the nominal repetitions of the PUSCH, that is, a mapping manner of the RV sequence is nominal-repetition-based RV mapping.

In the example in FIG. 7, what is identical to the example in FIG. 6 is that the RV sequence corresponding to TRP #1 is identical to the RV sequence corresponding to TRP #2, both of which are {0,2,3,1}. In addition, a difference (offset) between an RV of an n-th nominal repetition (or a transmission occasion of an actual repetition corresponding to a nominal repetition) of the PUSCH associated with TRP #1 and an RV of an n-th nominal repetition (or a transmission occasion of an actual repetition corresponding to a nominal repetition) of the PUSCH associated with TRP #2 is rvₛ; where, n is a natural number. And furthermore, the RVs are cyclically mapped according to a nominal repetition or a transmission occasion of actual repetition corresponding to the nominal repetition associated with each TRP, which are collectively referred to as “transmission occasions of actual repetitions corresponding to nominal repetitions” in the following description for the convenience of explanation.

FIG. 8 is a schematic diagram of a further example of the mapping relation between a dynamically scheduled PUSCH and an RV sequence. As shown in FIG. 8, the mapping relation between the PUSCH and the two TRPs is inter-actual-repetition TRP mapping, that is, the PUSCH is cyclically mapped (correlated) with the two TRPs in units of transmission occasions of the actual repetitions, while the RV sequence ({0,2,3,1} in FIG. 8) is cyclically mapped to the transmission occasions of the actual repetitions of the PUSCH, that is, a mapping manner of the RV sequence is actual-repetition-based RV mapping.

In the example in FIG. 8, what is identical to the examples in FIGS. 6 and 7 is that the RV sequence corresponding to TRP #1 is identical to the RV sequence corresponding to TRP #2, both of which are {0,2,3,1}. In addition, a difference (offset) between an RV of an n-th actual repetition (or a transmission occasion of an actual repetition) of the PUSCH associated with TRP #1 and an RV of an n-th actual repetition (or a transmission occasion of an actual repetition) of the PUSCH associated with TRP #2 is rvₛ. And furthermore, the RVs are cyclically mapped according to an actual repetition or a transmission occasion of an actual repetition associated with each TRP, which are collectively referred to as “transmission occasions of actual repetitions” in the following description for the convenience of explanation.

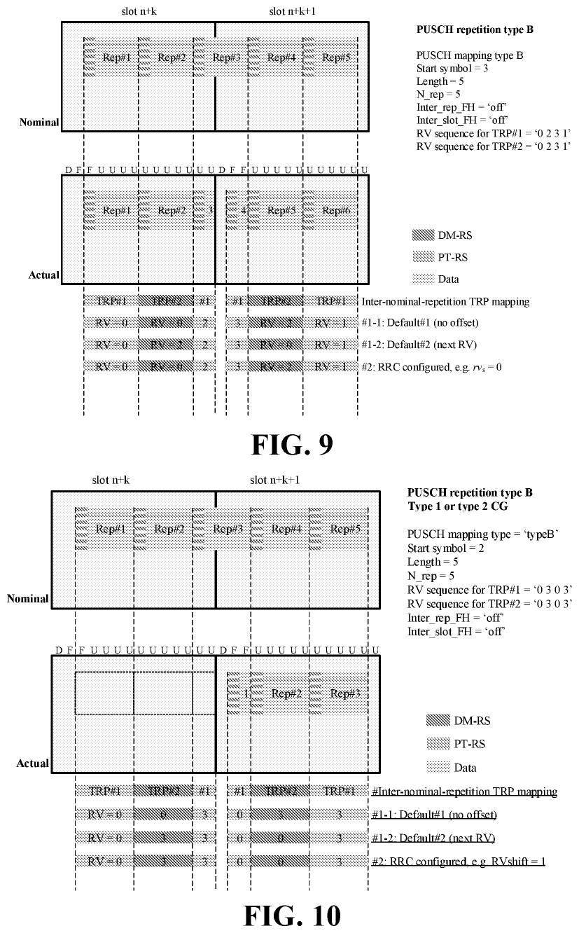

FIG. 9 is a schematic diagram of an example of a mapping relation between a configured grant PUSCH and an RV sequence. As shown in FIG. 9, the mapping relation between the PUSCH and the two TRPs is inter-nominal-repetition TRP mapping, that is, the PUSCH is cyclically mapped (correlated) with the two TRPs in units of transmission occasions of the nominal repetitions, while the RV sequence ({0,2,3,1} in FIG. 9) is cyclically mapped to the transmission occasions of the actual repetitions of the PUSCH, that is, a mapping manner of the RV sequence is actual-repetition-based RV mapping.

In the example in FIG. 9, the RV sequence corresponding to TRP #1 is identical to the RV sequence corresponding to TRP #2, both of which are {0,2,3,1}. In addition, a difference (offset) between an RV of an n-th actual repetition (or a transmission occasion of an actual repetition) of the PUSCH associated with TRP #1 and an RV of an n-th actual repetition (or a transmission occasion of an actual repetition) of the PUSCH associated with TRP #2 is rvₛ. And furthermore, the RVs are cyclically mapped according to an actual repetition or a transmission occasion of an actual repetition associated with each TRP, which are collectively referred to as “transmission occasions of actual repetitions” in the following description for the convenience of explanation.

FIG. 10 is a schematic diagram of another example of the mapping relation between a configured grant PUSCH and an RV sequence. As shown in FIG. 10, the mapping relation between the PUSCH and the two TRPs is inter-nominal-repetition TRP mapping, that is, the PUSCH is cyclically mapped (correlated) with the two TRPs in units of transmission occasions of the nominal repetitions, while the RV sequence ({0,3,0,3} in FIG. 10) is cyclically mapped to the transmission occasions of the actual repetitions of the PUSCH, that is, a mapping manner of the RV sequence is actual-repetition-based RV mapping.

In the example in FIG. 10, the RV sequence corresponding to TRP #1 is identical to the RV sequence corresponding to TRP #2, both of which are {0,3,0,3}. In addition, a difference (cyclic shift) between an RV of an n-th actual repetition (or a transmission occasion of an actual repetition) of the PUSCH associated with TRP #1 and an RV of an n-th actual repetition (or a transmission occasion of an actual repetition) of the PUSCH associated with TRP #2 is RVshift. And furthermore, the RVs are cyclically mapped according to an actual repetition or a transmission occasion of an actual repetition associated with each TRP, which are collectively referred to as “transmission occasions of actual repetitions” in the following description for the convenience of explanation.

FIG. 11 is a schematic diagram of a further example of the mapping relation between a configured grant PUSCH and an RV sequence. As shown in FIG. 11, the mapping relation between the PUSCH and the two TRPs is inter-nominal-repetition TRP mapping, that is, the PUSCH is cyclically mapped (correlated) with the two TRPs in units of transmission occasions of the nominal repetitions, while the RV sequence ({0,0,0,0} in FIG. 11) is cyclically mapped to the transmission occasions of the actual repetitions of the PUSCH, that is, a mapping manner of the RV sequence is actual-repetition-based RV mapping.

In the examples in FIGS. 9-11, only that the mapping relation between the PUSCH and the two TRPs is inter-nominal repetition TRP mapping is taken as an example. This disclosure is not limited thereto, and the TRP mapping manner may also be inter-actual repetition TRP mapping. Furthermore, in addition to the actual-repetition-based RV mapping, the mapping manner of the RV sequence may also be nominal-repetition-based RV mapping; however, this disclosure is not limited thereto, and reference may be made to the implementation of FIG. 7 for specific implementations.

In the embodiments of this disclosure, in some embodiments, the RV of the first transmission occasion of the uplink data is related to the RV of the second transmission occasion of the uplink data, wherein the first transmission occasion refers to a transmission occasion in transmission occasions of the uplink data associated with the first TRP in the two TRPs, and the second transmission occasion refers to a transmission occasion in the transmission occasions of the uplink data associated with the second TRP in the two TRPs, that is, in the transmission occasions of the uplink data, an RV of the transmission occasion associated with TRP #1 (the first transmission occasion) is related to an RV of the transmission occasion associated with TRP #2 (the second transmission occasion). Thus, the terminal equipment may improve combined gains of the uplink data by using the relation between the RVs. This is because compared with a case where transmission occasions associated with different TRPs are not related, the RV of the transmission occasion associated with TRP #1 is related to the RV of the transmission occasion associated with TRP #2, so that in a scenario where the transmission occasion associated with TRP #1 and the transmission occasion associated with TRP #2 are neighboring in a time domain and a probability of blockage is relatively low (that is, it is very probable that neighbored transmission occasions associated with TRP #1 and associated with TRP #2 may be received at the same time), higher combined gains may be achieved by optimizing corresponding RVs.

In some embodiments, a sequence number related to the first transmission occasion is identical to a sequence number related to the second transmission occasion. Here, the sequence numbers may either be sequence numbers of nominal repetitions corresponding to the transmission occasions, or sequence numbers of actual repetitions corresponding to the transmission occasions.

In some embodiments, that the RV of the first transmission occasion of the uplink data is related to the RV of the second transmission occasion of the uplink data refers to that, a difference between the RV of the first transmission occasion and the RV of the second transmission occasion is indicated by RRC signaling. Hence, a network device may semi-statically adjust the RV of the transmission occasion of the PUSCH corresponding to TRP #2 via the RRC signaling according to an actual situation, so as to improve combined gains of corresponding uplink data signals, and thus improve the system performance accordingly.

In the above embodiments, the difference may be an offset, such as rvₛ shown in FIGS. 6-9, or may be a shift, such as RV shift shown in FIG. 10.

In some embodiments, that the RV of the first transmission occasion of the uplink data is related to the RV of the second transmission occasion of the uplink data refers to that, a difference between the RV of the first transmission occasion and the RV of the second transmission occasion is indicated by DCI signaling. Thus, the network device may flexibly indicate a corresponding RV according to each time of transmission of the PUSCH, so as to obtain a maximum combined gain.

In the above embodiments, it is applicable to a dynamically scheduled PUSCH, such as the scenarios shown in FIGS. 6-8.

For example, the above difference is indicated by a corresponding unit of a TDRA field of the above DCI signaling. Therefore, it is not needed to add extra DCI fields, which is beneficial to reduce a size of the DCI, thereby improving reliability of a control channel.

For another example, the above difference is indicated by a field of the DCI signaling. As a result, it is relatively simple, with low implementation difficulty and cost, and little impact is imposed on standardization.

In some embodiments, that the RV of the first transmission occasion of the uplink data is related to the RV of the second transmission occasion of the uplink data refers to that, the RV of the first transmission occasion and the RV of the second transmission occasion are identical. In this method, no extra indications are needed, indication overhead is saved, and furthermore, this method is simple, and hardware implementation is facilitated.

In some embodiments, that the RV of the first transmission occasion of the uplink data is related to the RV of the second transmission occasion of the uplink data refers to that, a difference between the RV of the first transmission occasion and the RV of the second transmission occasion is determined according to a third transmission occasion; wherein the third transmission occasion refers to a last transmission occasion before the second transmission occasion associated with the first TRP in the two TRPs. Similarly, in this method, no extra indications are needed, indication overhead is saved, and furthermore, in this method, when a probability of blockage is relatively low, that is, it is very probable that neighbored transmission occasions associated with TRP #1 and associated with TRP #2 may be received at the same time, higher combined gains may be achieved by specifying a relation between RVs of neighboring transmission occasions.

In the embodiments of this disclosure, in some embodiments, as shown in FIG. 5, the method may further include:

502: a terminal equipment receives indication information, wherein the indication information indicates the RV of the transmission occasion of the uplink data associated with the first TRP in the two TRPs, and the indication information is contained in DCI signaling or RRC signaling.

According to the above embodiment, the terminal equipment may learn the RV of the transmission occasion of the PUSCH associated with the first TRP (TRP #1) in the two TRPs, and on this basis, the terminal equipment may determine the RV of the transmission occasion associated with the second TRP (TRP #2) in the two TRPs.

For example, in the previous embodiments, the RV of the transmission occasion associated with TRP #1 is related to the RV of the transmission occasion associated with TRP #2, and the terminal equipment may use the correlation therebetween to determine the RV of the transmission occasion associated with TRP #2 based on the above received indication information according to the RV of the transmission occasion associated with TRP #1. Meanings of the correlation therebetween have been described above, and contents of which are incorporated herein, which shall not be described herein any further.

The above indications shall be described below by taking FIG. 6 as an example.

As shown in FIG. 6, for the case where the difference between the RV of the first transmission occasion and the RV of the second transmission occasion is indicated by the DCI signaling (dynamically indicated), in some embodiments, rv_{id} is indicated respectively by scheduling DCI (an RV field) corresponding to the PUSCH, and rvₛ is dynamically indicated by the DCI. More specifically, for example, rvₛ is indicated by a field of the DCI. In the example of FIG. 6, rvₛ=0.

Table 1 below shows an RV of a transmission occasion of an n-th actual repetition associated with TRP #1, or shows an RV of an n-th actual repetition associated with TRP #1. Table 2 below shows an RV of a transmission occasion of an n-th actual repetition associated with TRP #2, or shows an RV of an n-th actual repetition associated with TRP #2. It should be noted that in the example shown in FIG. 6, n=0,1,2 . . . ; for example, a 0-th actual repetition associated with TRP #1 is Rep #1, and a 0-th actual repetition associated with TRP #2 is Rep #2.

TABLE 1

| rv_{id} indicated | | | | |
|---|---|---|---|---|
| by the DCI | RV to be applied to n^{th} (transmission occasion of) | | | |
| scheduling | the actual repetitions associated with TRP#1 | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 2

| rv_{id} indicated | | | | |
|---|---|---|---|---|
| by the DCI | RV to be applied to n^{th} (transmission occasion of) | | | |
| scheduling | the actual repetitions associated with TRP#2 | | | |
| the PUSCH | n mod 4 = 0 | n mod 4 = 1 | n mod 4 = 2 | n mod 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 6 that when the DCI scheduling the PUSCH indicates that rv_{id}=0, according to Table 1, an RV of a transmission occasion of the 0-th actual repetition associated with TRP #1 is 0. As rvₛ=0 in this example, according to Table 2, an RV of a transmission occasion of the 0-th actual repetition associated with TRP #2 is also 0. In addition, an RV sequence applied by the transmission occasions of the actual repetitions associated with TRP #1 is {0,2,3,1}, and an RV sequence applied by the transmission occasions of the actual repetitions associated with TRP #2 is also {0,2,3,1}.

As shown in FIG. 6, for the case where the RV of the first transmission occasion is identical to the RV of the second transmission occasion (default #1), in some embodiments, rv_{id} is indicated by the scheduling DCI (an RV field) corresponding to the PUSCH. That is, for the uplink data, the RV of the n-th transmission occasion associated with TRP #1 is identical to the RV of the n-th transmission occasion associated with TRP #2.

Table 3 below shows the RV of the transmission occasion of the n-th actual repetition associated with TRP #1 or TRP #2.

TABLE 3

| rv_{id} indicated | | | | |
|---|---|---|---|---|
| by the DCI | RV to be applied to n^{th} (transmission occasion of the) | | | |
| scheduling | actual repetitions associated with TRP#1 or TRP#2 | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

It can be seen from FIG. 6 that when the DCI scheduling the PUSCH indicates that rv_{id}=0, according to Table 3, the RV of the transmission occasion of the 0-th actual repetition associated with TRP #1 is identical to the RV of the transmission occasion of the 0-th actual repetition associated with TRP #2, both of which are 0. In addition, the RV sequence applied by the transmission occasion of the actual repetition associated with TRP #1 is {0,2,3,1}, and the RV sequence applied by the transmission occasion of the actual repetition associated with TRP #2 is also {0,2,3,1}.

As shown in FIG. 6, for the case where the difference between the RV of the first transmission occasion and the RV of the second transmission occasion is determined according to the third transmission occasion (default #2), in some embodiments, rv_{id} is indicated by the scheduling DCI (an RV field) corresponding to the PUSCH. And rvₛ is determined by a transmission occasion (the third transmission occasion) of a last actual repetition associated with TRP #1 before the second transmission occasion.

For example, in FIG. 6, for the second transmission occasion with a sequence number of 0 (i.e. n=0), before the second transmission occasion, according to FIG. 6, an RV of the transmission occasion (the third transmission occasion) of the last actual repetition (actual Rep #1) corresponding to TRP #1 is 0, and an RV next to the RV of the 0-th actual repetition associated with TRP #2 that is 0 is 2 (according to an order of 0-2-3-1), thus, rvₛ=2-0=2. And RVs of other transmission occasions may be calculated according to rvₛ=2. Furthermore, an RV sequence applied by the transmission occasion of the actual repetition associated with TRP #1 is {0,2,3,1}, and the RV sequence applied by the transmission occasion of the actual repetition associated with TRP #2 is also {0,2,3,1}.

As shown in FIG. 6, for the case where the difference between the RV of the first transmission occasion and the RV of the second transmission occasion is indicated by the RRC signaling (RRC configured), in some embodiments, rv_{id} is indicated by the scheduling DCI (an RV field) corresponding to the PUSCH, and rvₛ is configured by RRC signaling. In the example of FIG. 6, rvₛ=0.

Table 4 below shows the RV of the transmission occasion of the n-th actual repetition associated with TRP #1, and Table 5 below shows the RV of the transmission occasion of the n-th actual repetition associated with TRP #2.

TABLE 4

| rv_{id} indicated | | | | |
|---|---|---|---|---|
| by the DCI | RV to be applied to n^{th} (transmission occasion of) | | | |
| scheduling | the actual repetitions associated with TRP#1 | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 5

| rv_{id} | | | | |
|---|---|---|---|---|
| indicated | | | | |
| by the | | | | |
| DCI | | | | |
| scheduling | RV to be applied to n^{th} (transmission occasion of) | | | |
| the | the actual repetitions associated with TRP#2 | | | |
| PUSCH | n mod 4 = 0 | n mod 4 = 1 | n mod 4 = 2 | n mod 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 6 that when the DCI scheduling the PUSCH indicates that rv_{id}=0, according to Table 4, the RV of the transmission occasion of the 0-th actual repetition associated with TRP #1 is 0. As rvₛ=0 in this example, according to Table 5, the RV of the transmission occasion of the 0-th actual repetition associated with TRP #2 is also 0. In addition, the RV sequence applied by the transmission occasion of the actual repetition associated with TRP #1 is {0,2,3,1}, and the RV sequence applied by the transmission occasion of the actual repetition associated with TRP #2 is also {0,2,3,1}.

The above indications shall be described below by taking FIG. 7 as an example.

As shown in FIG. 7, for the case where the difference between the RV of the first transmission occasion and the RV of the second transmission occasion is indicated by the DCI signaling (dynamically indicated), in some embodiments, rv_{id} is indicated respectively by scheduling DCI (an RV field) corresponding to the PUSCH, and rvₛ is dynamically indicated by the DCI. More specifically, for example, rvₛ is indicated by a field of the DCI. In the example of FIG. 7, rvₛ=0.

Table 6 below shows an RV of any transmission occasion of all actual repetitions of an n-th nominal repetition associated with TRP #1, and Table 7 below shows an RV of any transmission occasion of all actual repetitions of the n-th nominal repetition associated with TRP #2. It should be noted that in the example shown in FIG. 7, n=0,1,2 . . . ; for example, a 0-th nominal repetition associated with TRP #1 is Nominal Rep #1, and a 0-th nominal repetition associated with TRP #2 is Nominal Rep #2.

TABLE 6

| rv_{id} indicated | RV to be applied to any transmission occasion | | | |
|---|---|---|---|---|
| by the DCI | among all the actual repetitions of the n^{th} | | | |
| scheduling | nominal repetitions associated with TRP#1 | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 7

| rv_{id} | | | | |
|---|---|---|---|---|
| indicated | | | | |
| by the | RV to be applied to any | | | |
| DCI | transmission occasion among all the | | | |
| scheduling | actual repetitions of the n^{th} nominal | | | |
| the | repetitions associated with TRP#2 | | | |
| PUSCH | n mod 4 = 0 | n mod 4 = 1 | n mod 4 = 2 | n mod 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 7 that when the DCI scheduling the PUSCH indicates that rv_{id}=0, according to Table 6, an RV of any transmission occasion of all actual repetitions of a first nominal repetition associated with TRP #1 (Rep #3) is 2. As rvₛ=0 in this example, according to Table 7, an RV of any transmission occasion of all actual repetitions of a first nominal repetition associated with TRP #2 (Rep #4) is also 2. In addition, an RV sequence applied by the nominal repetition associated with TRP #1 is {0,2,3,1}, and an RV sequence applied by the nominal repetition associated with TRP #2 is also {0,2,3,1}.

As shown in FIG. 7, for the case where the RV of the first transmission occasion is identical to the RV of the second transmission occasion (default #1), in some embodiments, rv_{id} is indicated by the scheduling DCI (an RV field) corresponding to the PUSCH. That is, the RV of any transmission occasion of all actual repetitions of the n-th nominal repetition associated with TRP #1 is identical to the RV of any transmission occasion of all actual repetitions of the n-th nominal repetition associated with TRP #2.

Table 8 below shows the RV of any transmission occasion of all actual repetitions of the n-th nominal repetition associated with TRP #1 or TRP #2.

TABLE 8

| rv_{id} indicated | RV to be applied to any transmission occasion among | | | |
|---|---|---|---|---|
| by the DCI | all the actual repetitions of the n^{th} nominal repetitions | | | |
| scheduling | associated with TRP#1 or TRP#2, respectively | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

It can be seen from FIG. 7 that when the DCI scheduling the PUSCH indicates that rv_{id}=0, according to Table 8, an RV of any transmission occasion of all actual repetitions of a first nominal repetition associated with TRP #1 (Rep #3) and an RV of any transmission occasion of all actual repetitions of a first nominal repetition associated with TRP #2 (Rep #4) are both 2. In addition, an RV sequence applied by the nominal repetition associated with TRP #1 is {0,2,3,1}, and an RV sequence applied by the nominal repetition associated with TRP #2 is also {0,2,3,1}.

As shown in FIG. 7, for the case where the difference between the RV of the first transmission occasion and the RV of the second transmission occasion is determined according to the third transmission occasion (default #2), in some embodiments, rv_{id} is indicated by the scheduling DCI (an RV field) corresponding to the PUSCH. And rvₛ is determined by a transmission occasion of a last actual repetition associated with TRP #1 before the second transmission occasion.

For example, in FIG. 7, for the second transmission occasion with a sequence number of 0 (i.e. n=0), before the second transmission occasion, according to FIG. 7, an RV of the transmission occasion (the third transmission occasion) of the last actual repetition (Rep #1) corresponding to TRP #1 is 0, and an RV next to the RV of the 0-th actual repetition associated with TRP #2 that is 0 is 2 (according to an order of 0-2-3-1), thus, rvₛ=2-0=2. And RVs of other transmission occasions may be calculated according to rvₛ=2. Furthermore, an RV sequence applied by the nominal repetition associated with TRP #1 is {0,2,3,1}, and the RV sequence applied by the nominal repetition associated with TRP #2 is also {0,2,3,1}.

As shown in FIG. 7, for the case where the difference between the RV of the first transmission occasion and the RV of the second transmission occasion is indicated by the RRC signaling (RRC configured), in some embodiments, rv_{id} is indicated by scheduling DCI (an RV field) corresponding to the PUSCH, and rvₛ is configured by the RRC signaling. In the example of FIG. 7, rvₛ=0.

Table 9 below shows an RV of any transmission occasion of all actual repetitions of an n-th nominal repetition associated with TRP #1, and Table 10 below shows an RV of any transmission occasion of all actual repetitions of the n-th nominal repetition associated with TRP #2.

TABLE 9

| | RV to be applied to any transmission occasion | | | |
|---|---|---|---|---|
| rv_{id} indicated | among all the actual repetitions of the n^{th} | | | |
| by the DCI | nominal repetitions associated with TRP#1 | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 10

| | RV to be applied to any transmission occasion | | | |
|---|---|---|---|---|
| rv_{id} indicated | among all the actual repetitions of the n^{th} | | | |
| by the DCI | nominal repetitions associated with TRP#2 | | | |
| scheduling | n mod | n mod | n mod | n mod |
| the PUSCH | 4 = 0 | 4 = 1 | 4 = 2 | 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 7 that when the DCI scheduling the PUSCH indicates that rv_{id}=0, according to Table 9, the RV of any transmission occasion of all actual repetitions of the first nominal repetition associated with TRP #1 (Rep #3) is 2. As rvₛ=0 in this example, according to Table 10, the RV of any transmission occasion of all actual repetitions of the first nominal repetition associated with TRP #2 (Rep #4) is also 2. In addition, the RV sequence applied by the nominal repetition associated with TRP #1 is {0,2,3,1}, and the RV sequence applied by the nominal repetition associated with TRP #2 is also {0,2,3,1}.

The above indications shall be described below by taking FIG. 8 as an example.

As shown in FIG. 8, for the case where the difference between the RV of the first transmission occasion and the RV of the second transmission occasion is indicated by the DCI signaling (dynamically indicated), in some embodiments, rv_{id} is indicated respectively by scheduling DCI (an RV field) corresponding to the PUSCH, and rvₛ is dynamically indicated by the DCI. In the example of FIG. 8, rvₛ=1.

Table 11 below shows an RV sequence applied by a transmission occasion of an n-th actual repetition associated with TRP #1, and Table 12 below shows an RV sequence applied by a transmission occasion of an n-th actual repetition associated with TRP #2. It should be noted that in the example shown in FIG. 8, n=0,1,2 . . . ; for example, a 0-th actual repetition associated with TRP #1 is Actual Rep #1, and a 0-th actual repetition associated with TRP #2 is Actual Rep #2.

TABLE 11

| rv_{id,1} indicated | RV to be applied to n^{th} (transmission occasion of) | | | |
|---|---|---|---|---|
| by the DCI | the actual repetitions associated with TRP#1 | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 12

| rv_{id} indicated | RV to be applied to n^{th} (transmission occasion of) | | | |
|---|---|---|---|---|
| by the DCI | the actual repetitions associated with TRP#2 | | | |
| scheduling | n mod | n mod | n mod | n mod |
| the PUSCH | 4 = 0 | 4 = 1 | 4 = 2 | 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 8 that when the DCI scheduling the PUSCH indicates that rv_{id}=0, according to Table 11, an RV of a transmission occasion of a 0-th actual repetition associated with TRP #1 is 0. As rvₛ=1 in this example, according to Table 12, an RV of a transmission occasion of a 0-th actual repetition associated with TRP #2 is 1. In addition, an RV sequence applied by the actual repetition associated with TRP #1 is {0,2,3,1}, and an RV sequence applied by the actual repetition associated with TRP #2 is {0,2,3,1}.

As shown in FIG. 8, for the case where the RV of the first transmission occasion is identical to the RV of the second transmission occasion (default #1), in some embodiments, rv_{id} is indicated by the scheduling DCI (an RV field) corresponding to the PUSCH. That is, the RV of the transmission occasion of the n-th actual repetition associated with TRP #1 is identical to the RV of the transmission occasion of the n-th actual repetition associated with TRP #2.

Table 13 below shows the RV of the transmission occasion of the n-th actual repetition associated with TRP #1 or TRP #2.

TABLE 13

| | RV to be applied to n^{th} transmission | | | |
|---|---|---|---|---|
| rv_{id} indicated | occasion of the actual repetitions | | | |
| by the DCI | associated with TRP#1 or TRP#2 | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

It can be seen from FIG. 8 that when the DCI scheduling the PUSCH indicates that rv_{id}=0, according to Table 13, an RV of the transmission occasion of the 0-th actual repetition associated with TRP #1 is identical to an RV of the transmission occasion of the 0-th actual repetition associated with TRP #2, which are both 0. In addition, an RV sequence applied by the actual repetition associated with TRP #1 is {0,2,3,1}, and an RV sequence applied by the actual repetition associated with TRP #2 is also {0,2,3,1}.

As shown in FIG. 8, for the case where the difference between the RV of the first transmission occasion and the RV of the second transmission occasion is determined according to the third transmission occasion (default #2), in some embodiments, rv_{id} is indicated by the scheduling DCI (an RV field) corresponding to the PUSCH. And rvₛ is determined by a transmission occasion of a last actual repetition associated with TRP #1 before the second transmission occasion.

For example, in FIG. 8, for the second transmission occasion with a sequence number of 0 (i.e. n=0), before the second transmission occasion, according to FIG. 8, an RV of the transmission occasion (the third transmission occasion) of the last actual repetition (Rep #1) corresponding to TRP #1 is 0, and an RV next to the RV of the 0-th actual repetition associated with TRP #2 that is 0 is 2 (according to an order of 0-2-3-1), thus, rvₛ=2-0=2. And RVs of other transmission occasions may be calculated according to rvₛ=2. Furthermore, an RV sequence applied by the actual repetition associated with TRP #1 is {0,2,3,1}, and the RV sequence applied by the actual repetition associated with TRP #2 is {0,2,3,1}.

As shown in FIG. 8, for the case where the difference between the RV of the first transmission occasion and the RV of the second transmission occasion is indicated by the RRC signaling (RRC configured), in some embodiments, rv_{id} is indicated by scheduling DCI (an RV field) corresponding to the PUSCH, and rvₛ is configured by the RRC signaling. In the example of FIG. 8, rvₛ=3.

Table 14 below shows an RV of a transmission occasion of an n-th actual repetition associated with TRP #1, and Table 15 below shows an RV of a transmission occasion of an n-th actual repetition associated with TRP #2.

TABLE 14

| | RV to be applied to n^{th} transmission | | | |
|---|---|---|---|---|
| rv_{id} indicated | occasion of the actual repetitions | | | |
| by the DCI | associated with TRP#1 | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 15

| | RV to be applied to n^{th} transmission | | | |
|---|---|---|---|---|
| rv_{id} indicated | occasion of the actual repetitions | | | |
| by the DCI | associated with TRP#2 | | | |
| scheduling | n mod | n mod | n mod | n mod |
| the PUSCH | 4 = 0 | 4 = 1 | 4 = 2 | 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 8 that when the DCI scheduling the PUSCH indicates that rv_{id}=0, according to Table 14, the RV of the transmission occasion of the 0-th actual repetition associated with TRP #1 is 0. As rvₛ=3 in this example, according to Table 15, the RV of the transmission occasion of the 0-th actual repetition associated with TRP #2 is 3. In addition, the RV sequence applied by the actual repetition associated with TRP #1 is {0,2,3,1}, and the RV sequence applied by the actual repetition associated with TRP #2 is also {0,2,3,1}.

The above indications shall be described below by taking FIG. 9 as an example.

As shown in FIG. 9, for the case where the RV of the first transmission occasion is identical to the RV of the second transmission occasion (default #1), in some embodiments, the RVs, i.e. the RV of the transmission occasion of the n-th actual repetition associated with TRP #1 and the RV of the transmission occasion of the n-th actual repetition associated with TRP #2, may be determined according to Table 22 below

Table 16 below shows the RV of the transmission occasion of the n-th actual repetition associated with TRP #1 or TRP #2. It should be noted that in the example shown in FIG. 9, n=0,1,2 . . . ; for example, a 0-th actual repetition associated with TRP #1 is Actual Rep #1, and a 0-th actual repetition associated with TRP #2 is Actual Rep #2.

TABLE 16
RV to be applied to n^{th} (transmission occasion of) the
actualrepetitions associated with TRP#1 or TRP#2

| n mod | n mod | n mod | n mod |
|---|---|---|---|
| 4 = 0 | 4 = 1 | 4 = 2 | 4 = 3 |
| 0 | 2 | 3 | 1 |

It can be seen from FIG. 9 that the RV of the transmission occasion of the 0-th actual repetition associated with TRP #1 is identical to the RV of the transmission occasion of the 0-th actual repetition associated with TRP #2, both of which are 0. In addition, the RV sequence applied by the transmission occasion of the actual repetition associated with TRP #1 is {0,2,3,1}, and the RV sequence applied by the transmission occasion of the actual repetition associated with TRP #2 is also {0,2,3,1}.

As shown in FIG. 9, for the case where the difference between the RV of the first transmission occasion and the RV of the second transmission occasion is determined according to the third transmission occasion (default #2), in some embodiments, rv_{id} is indicated by the scheduling DCI (an RV field) corresponding to the PUSCH. And rvₛ is determined by a transmission occasion of a last actual repetition associated with TRP #1 before the second transmission occasion.

For example, in FIG. 9, for the second transmission occasion with a sequence number of 0 (i.e. n=0), before the second transmission occasion, according to FIG. 9, an RV of the transmission occasion (the third transmission occasion) of the last actual repetition (Rep #1) corresponding to TRP #1 is 0, and an RV next to the RV of the 0-th actual repetition associated with TRP #2 that is 0 is 2 (according to an order of 0-2-3-1), thus, rvₛ=2-0=2. And RVs of other transmission occasions may be calculated according to rvₛ=2. Furthermore, an RV sequence applied by the transmission occasion of the actual repetition associated with TRP #1 is {0,2,3,1}, and the RV sequence applied by the transmission occasion of the actual repetition associated with TRP #2 is also {0,2,3,1}.

As shown in FIG. 9, for the case where the difference between the RV of the first transmission occasion and the RV of the second transmission occasion is indicated by the RRC signaling (RRC configured), in some embodiments, the RVs may be determined according to tables 17 and 18 below, wherein rvₛ is configured by RRC signaling. In the example of FIG. 9, rvₛ=0.

Table 17 below shows the RV of the transmission occasion of the n-th actual repetition associated with TRP #1, and Table 18 below shows the RV of the transmission occasion of the n-th actual repetition associated with TRP #2.

TABLE 17
RV to be applied to n^{th} (transmission occasion of)
the actual repetitions associated with TRP#1

| n mod | n mod | n mod | n mod |
|---|---|---|---|
| 4 = 0 | 4 = 1 | 4 = 2 | 4 = 3 |
| 0 | 2 | 3 | 1 |

TABLE 18
RV to be applied to n^{th} transmission occasion of
the actual repetitions associated with TRP#2

| n mod | n mod | n mod | n mod |
|---|---|---|---|
| 4 = 0 | 4 = 1 | 4 = 2 | 4 = 3 |
| (0 + rvₛ) | (2 + rvₛ) | (3 + rvₛ) | (1 + rvₛ) |
| mod 4 | mod 4 | mod 4 | mod 4 |

It can be seen from FIG. 9 that according to Table 17, an RV of a transmission occasion of a 0-th actual repetition associated with TRP #1 is 0. As rvₛ=0 in this example, according to Table 18, an RV sequence applied by the transmission occasion of the 0-th actual repetition associated with TRP #2 is also 0. In addition, an RV sequence applied by the transmission occasion of the actual repetition associated with TRP #1 is {0,2,3,1}, and an RV sequence applied by the transmission occasion of the actual repetition associated with TRP #2 is also {0,2,3,1}.

The above indications shall be described below by taking FIG. 10 as an example.

As shown in FIG. 10, when the RV of the first transmission occasion is identical to the RV of the second transmission occasion (default #1), in some embodiments, the RVs may be determined according to Table 19, that is, for uplink data, the RV of the transmission occasion of the n-th actual repetition associated with TRP #1 is identical to the RV of the transmission occasion of the n-th actual repetition associated with TRP #2.

Table 19 below shows an RV sequence applied by the transmission occasion of the n-th actual repetition associated with TRP #1 or TRP #2. It should be noted that in the example shown in FIG. 10, n=0,1,2 . . . ; for example, a second actual repetition associated with TRP #1 is Actual Rep #1, and a first actual repetition associated with TRP #2 is Actual Rep #2. It should be noted that transmission occasions that are not used for transmitting data need to be taken into account (portions in dashed lines in FIG. 10).

TABLE 19
RV to be applied to n^{th} (transmission occasion of) the
actual repetitions associated with TRP#1 or TRP#2

| n mod | n mod | n mod | n mod |
|---|---|---|---|
| 4 = 0 | 4 = 1 | 4 = 2 | 4 = 3 |
| 0 | 3 | 0 | 3 |

It can be seen from FIG. 10 that according to Table 19, the RV of the transmission occasion of the 0-th actual repetition associated with TRP #1 is identical to the RV of the transmission occasion of the 0-th actual repetition associated with TRP #2, both of which are 0. In addition, the RV sequence applied by the transmission occasion of the actual repetition associated with TRP #1 is {0,3,0,3}, and the RV sequence applied by the transmission occasion of the actual repetition associated with TRP #2 is also {0,3,0,3}.

As shown in FIG. 10, for the case where the difference between the RV of the first transmission occasion and the RV of the second transmission occasion is determined according to the third transmission occasion (default #2), in some embodiments, rv_{id} is indicated by the scheduling DCI (an RV field) corresponding to the PUSCH. And RVshift is determined by a transmission occasion of a last actual repetition associated with TRP #1 before the second transmission occasion.

For example, in FIG. 10, for the second transmission occasion with a sequence number of 0 (i.e. n=0), before the second transmission occasion, according to FIG. 10, an RV of the transmission occasion (the third transmission occasion) of the last actual repetition (Rep #1) corresponding to TRP #1 is 0, and an RV next to the RV of the 0-th actual repetition associated with TRP #2 that is 0 is 3 (according to an order of 0-3-0-3), thus, RVshift=1 (that is, 3 is taken as a starting RV, as shown in Table 21). And RVs of other transmission occasions may be derived according to RVshift=1 with reference to Table 21. Furthermore, an RV sequence applied by the transmission occasion of the actual repetition associated with TRP #1 is {0,3,0,3}, and the RV sequence applied by the transmission occasion of the actual repetition associated with TRP #2 is also {0,3,0,3}.

As shown in FIG. 10, for the case where the difference between the RV of the first transmission occasion and the RV of the second transmission occasion is indicated by the RRC signaling (RRC configured), in some embodiments, the RVs may be determined according to tables 20 and 21, wherein RVshift is configured by RRC signaling. In the example of FIG. 10, RVshift=1.

Table 20 below shows the RV of the transmission occasion of the n-th actual repetition associated with TRP #1, and Table 21 below shows the RV of the transmission occasion of the n-th actual repetition associated with TRP #2.

TABLE 20
RV to be applied to n^{th} (transmission occasion of)
the actual repetitions associated with TRP#1

| n mod | n mod | n mod | n mod |
|---|---|---|---|
| 4 = 0 | 4 = 1 | 4 = 2 | 4 = 3 |
| 0 | 2 | 3 | 1 |

TABLE 21

| | RV to be applied to n^{th} (transmission occasion of) | | | |
|---|---|---|---|---|
| | the actual repetitions associated with TRP#2 | | | |
| | n mod | n mod | n mod | n mod |
| RVshift | 4 = 0 | 4 = 1 | 4 = 2 | 4 = 3 |
| 0 | 0 | 3 | 0 | 3 |
| 1 | 3 | 0 | 3 | 0 |

It can be seen from FIG. 10 that according to Table 20, an RV applied by a transmission occasion of a 0-th actual repetition associated with TRP #1 is 0. As RVshift=1 in this example, according to Table 21, an RV of the transmission occasion of the 0-th actual repetition associated with TRP #2 is 3. In addition, an RV sequence applied by the transmission occasion of the actual repetition associated with TRP #1 is {0,3,0,3}, and an RV sequence applied by the transmission occasion of the actual repetition associated with TRP #2 is also {0,3,0,3}.

The above indications shall be described below by taking FIG. 11 as an example.

As shown in FIG. 11, the RV sequence applied by the transmission occasion of the actual repetition associated with TRP #1 is {0,0,0,0}, and the RV sequence applied by the transmission occasion of the actual repetition associated with TRP #2 is {0,0,0,0}. That is, RVs of the transmission occasions of the uplink data are all 0. It should be noted that in the example shown in FIG. 11, n=0,1,2, . . . ; for example, a second actual repetition associated with TRP #1 is Actual Rep #1, and a first actual repetition associated with TRP #2 is Actual Rep #2. It should be noted that transmission occasions that are not used for transmitting data need to be taken into account (portions in dashed lines in FIG. 11).

In the above embodiments, in some embodiments, the RV sequence applied by the transmission occasion in the at least two transmission occasions of the uplink data associated with the first TRP in the above two TRPs is identical to the RV sequence applied by the transmission occasion in the at least two transmission occasions of the uplink data associated with the second TRP in the above two TRPs. Therefore, multiple TRPs may apply identical RV sequences, thereby saving signaling overhead.

In the embodiments of this disclosure, in some embodiments, the uplink data start from the transmission occasion of the actual repetition associated with the first TRP (TRP #1) in the two TRPs and with a corresponding RV of 0. Therefore, the terminal equipment is only allowed to transmit PUSCH transmission at a transmission occasion with relatively high reliability, this is advantageous for in case of a large CG, the network device needs only to assume that PUSCH transmission may occur on a part of PUSCH transmission occasions. In this way, the number of times of blind detection at the network side may be reduced, and the design complexity at the network side may be lowered.

Taking FIG. 10 as an example, the PUSCH starts only from some PUSCH transmission occasions. That is, if a configured RV sequence is {0,3,0,3}, initial transmission of a transmission block of the configured grant may start from any transmission occasion of an actual repetition associated with TRP #1 and with RV=0.

As shown in FIG. 10, as RV=0, the PUSCH may be transmitted starting from the transmission occasion of the 0-th or second actual repetition associated with TRP #1.

Taking FIG. 11 as an example, the PUSCH starts only from some PUSCH transmission occasions. That is, if a configured RV sequence is {0,0,0,0}, the initial transmission of the transmission block of the configured grant may start from any transmission occasion of the actual repetition associated with TRP #1 and with RV=0.

As shown in FIG. 11, as RV=0, the PUSCH is transmitted starting from a transmission occasion of a 0-th, or a first, or a second or a third actual repetition associated with TRP #1.

In the embodiments of this disclosure, in some embodiments, that the at least one transmission occasion of the uplink data is associated with two TRPs refers to that,

the at least one transmission occasion of the uplink data is respectively related (mapped) to the two TRPs in unit of transmission occasion of at least one nominal repetition of the uplink data; or

the at least one transmission occasion of the uplink data is respectively related (mapped) to the two TRPs in unit of transmission occasion of at least one actual repetition of the uplink data; or

the at least one transmission occasion of the uplink data is respectively related (mapped) to the two TRPs in unit of at least one slot.

Specific implementations are not limited in the embodiments of this disclosure.

In the embodiment of this disclosure, the TRP is equivalent to at least one of the following:

a transmission configuration indication (TCI) state;

a spatial relation;

a reference signal;

a reference signal group;

an SRS resource group (containing one or more SRS resources);

a spatial domain filter;

a power control parameter; and

a group of time alignment (TA) related parameters.

Reference may be made to relevant technologies for specific meanings of the above concepts, which shall not be repeated herein any further.

For example, that the at least one transmission occasion of the PUSCH is associated with at least two TRPs is equivalent to that, the at least one transmission occasion of the PUSCH is associated with at least two TCI states, that is, the terminal equipment transmits the PUSCH according to parameters corresponding to the above at least two TCI states.

For another example, that the at least one transmission occasion of the PUSCH is associated with at least two TRPs is equivalent to that, the at least one transmission occasion of the PUSCH is associated with at least two spatial relations.

For a further example, that the at least one transmission occasion of the PUSCH is associated with at least two TRPs is equivalent to that, the at least one transmission occasion of the PUSCH is associated with at least two reference signals. Here, the reference signals may be pathloss reference signals (RSs), or CSI-RSs (channel state information reference signals), SSBs (synchronization signal blocks), SRSs (sounding reference signals), etc.; however, this disclosure is not limited thereto.

For still another example, that the at least one transmission occasion of the PUSCH is associated with at least two TRPs is equivalent to that, the at least one transmission occasion of the PUSCH is associated with at least two reference signal groups. A reference signal group is one or more reference signals (RSs). Here, the reference signal may be a pathloss reference signal (RS), or a CSI-RS (channel state information reference signal), an SSB (synchronization signal block), an SRS (sounding reference signal), etc.; however, this disclosure is not limited thereto.

For yet another example, that the at least one transmission occasion of the PUSCH is associated with at least two TRPs is equivalent to that, the at least one transmission occasion of the PUSCH is associated with at least two spatial filters.

For yet still another example, that the at least one transmission occasion of the PUSCH is associated with at least two TRPs is equivalent to that, the at least one transmission occasion of the PUSCH is associated with at least two power control parameters.

It should be noted that FIG. 5 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

According to the method of the embodiment of this disclosure, it may be ensured that in case of blockage, even if only a part of TRPs may operate, compared with a case where the RV is unassociated with TRPs, there may have higher combined gains. This is because this method enables an RV of a transmission occasion of the above uplink data to be adjusted according to information on the TRPs, that is, in a case where TRPs corresponding to the transmission occasions of the uplink data are different, or when a probability that corresponding TRPs are blocked changes, an RV of each transmission occasion may be optimally determined according to the information on the TRPs, thereby improving performances of the system.

### Embodiment of a Second Aspect

The embodiment of this disclosure provides a method for transmitting uplink data, which shall be described from a terminal equipment side. What is different from the embodiment of the first aspect is that the method of the embodiment of this disclosure is applicable to transmitting uplink data (PUSCHs) in the manner of PUSCH repetition type A, with contents identical to those in the embodiment of the first aspect being not going to be repeated any further. Moreover, the embodiment of this disclosure shall be described by taking the scenario of the dynamically scheduled PUSCH shown in FIG. 1 and the scenario of the configured grant PUSCH shown in FIG. 2 as examples.

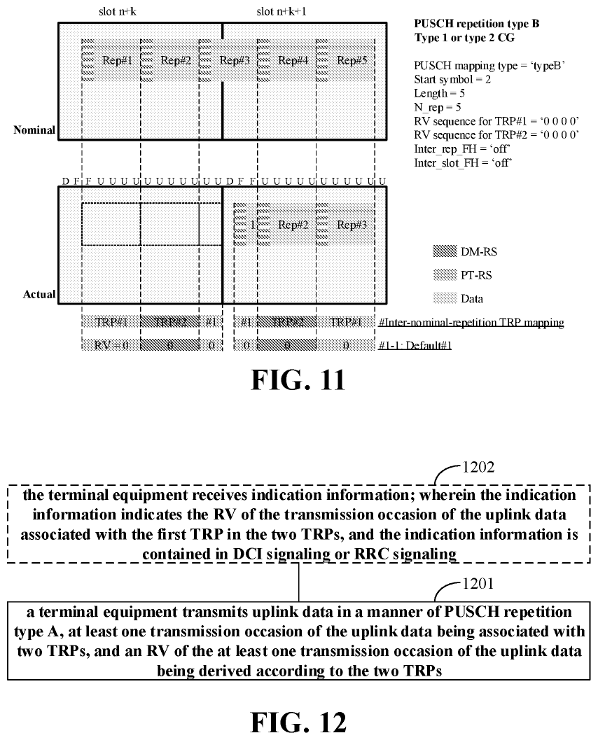

FIG. 12 is a schematic diagram of the method for transmitting uplink data of the embodiment of this disclosure. As shown in FIG. 12, the method includes:

1201: a terminal equipment transmits uplink data in a manner of PUSCH repetition type A, at least one transmission occasion of the uplink data being associated with two TRPs, and an RV of the at least one transmission occasion of the uplink data being derived according to the two TRPs.

According to the method of the embodiment of this disclosure, it may be ensured that in case of blockage, even if only a part of TRPs may operate, compared with a case where the RV is unassociated with TRPs, there may have higher combined gains. This is because this method enables an RV of a transmission occasion of the above uplink data to be adjusted according to information on the TRPs, that is, in a case where TRPs corresponding to the transmission occasions of the uplink data are different, or when a probability that corresponding TRPs are blocked changes, an RV of each transmission occasion may be optimally determined according to the information on the TRPs, thereby improving performances of the system.

In some embodiments, that an RV of at least one transmission occasion of the uplink data is derived according to the two TRPs refers to that,

an RV of a transmission occasion in the at least one transmission occasion of the uplink data associated with a first TRP in the two TRPs is derived from a time domain order of the transmission occasion associated with the first TRP, and an RV of a transmission occasion in the at least one transmission occasion of the uplink data associated with a second TRP in the two TRPs is derived from a time domain order of the transmission occasion associated with the second TRP. That is, an RV sequence is cyclically mapped according to transmission occasions of the PUSCH.

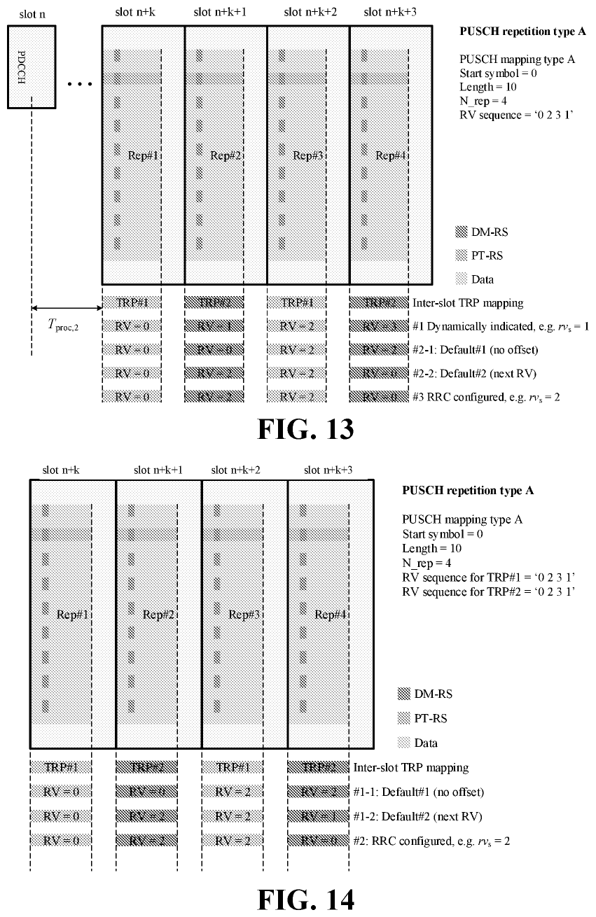

FIG. 13 is a schematic diagram of an example of a mapping relation between a dynamically scheduled PUSCH and an RV sequence. As shown in FIG. 13, the mapping relation between the PUSCH and the two TRPs is inter-slot TRP mapping, that is, the PUSCH is cyclically mapped (correlated) with the two TRPs in unit of a transmission occasion, and the RV sequence ({0,2,3,1} in FIG. 13) is cyclically mapped to transmission occasions within slots of the PUSCH, that is, a mapping manner of the RV sequences is slot-based RV mapping.

In the example of FIG. 13, an RV sequence applied by the transmission occasion associated with TRP #1 is identical to an RV sequence applied by the transmission occasion associated with TRP #2, both of which are {0,2,3,1}. In addition, a difference (offset) between an RV of an n-th transmission occasion of the PUSCH associated with TRP #1 and an RV of an n-th transmission occasion of the PUSCH associated with TRP #2 is rvₛ; where, n is a natural number. And furthermore, the RVs are cyclically mapped according to transmission occasions associated with each TRP.

FIG. 14 is a schematic diagram of an example of the mapping relation between a configured grant PUSCH and an RV sequence. As shown in FIG. 14, a TRP mapping manner of the PUSCH and a mapping manner of an RV sequence are identical to those in FIG. 13.

In the example of FIG. 14, an RV sequence corresponding to TRP #1 is identical to an RV sequence corresponding to TRP #2, both of which are {0,2,3,1}. In addition, a difference (offset) between an RV of an n-th transmission occasion of the PUSCH associated with TRP #1 and an RV of an n-th transmission occasion of the PUSCH associated with TRP #2 is rvₛ. And furthermore, the RVs are cyclically mapped according to transmission occasions associated with each TRP.

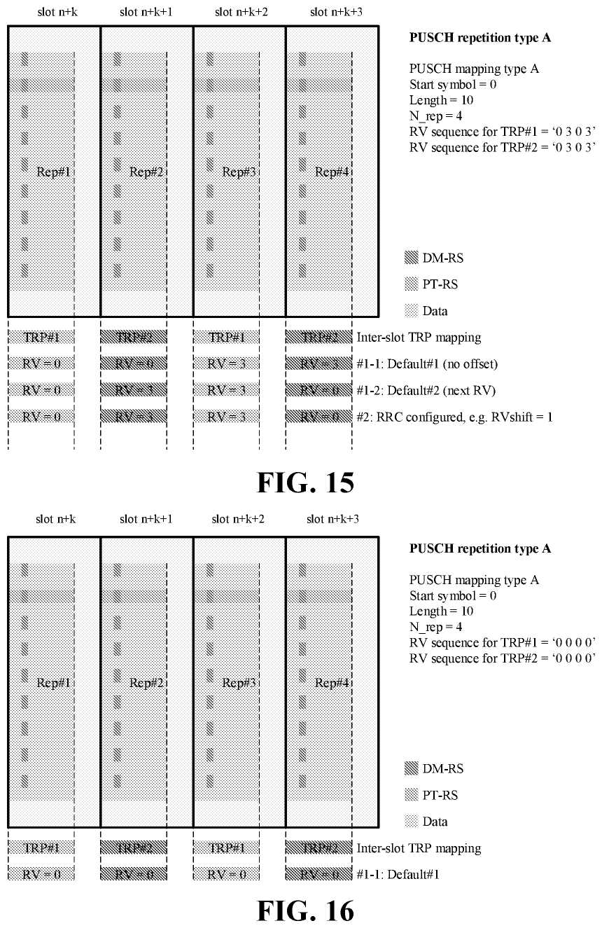

FIG. 15 is a schematic diagram of another example of the mapping relation between a configured grant PUSCH and an RV sequence. As shown in FIG. 15, a TRP mapping manner of the PUSCH and a mapping manner of an RV sequence are identical to those in FIG. 13.

In the example in FIG. 15, what is different from the example in FIG. 14 is that the RV sequence corresponding to TRP #1 is identical to the RV sequence corresponding to TRP #2, both of which are {0,3,0,3}. In addition, a difference (cyclic shift) between the RV of the n-th transmission occasion of the PUSCH associated with TRP #1 and the RV of the n-th transmission occasion of the PUSCH associated with TRP #2 is RVshift.

FIG. 16 is a schematic diagram of a further example of the mapping relation between a configured grant PUSCH and an RV sequence. As shown in FIG. 16, the RV sequence corresponding to TRP #1 is identical to the RV sequence corresponding to TRP #2, both of which are {0,0,0,0}.

In some embodiments, the RV of the first transmission occasion of the uplink data is related to the RV of the second transmission occasion of the uplink data, wherein the first transmission occasion refers to a transmission occasion in the transmission occasions of the uplink data associated with a first TRP in the two TRPs, and the second transmission occasion refers to a transmission occasion in the transmission occasions of the uplink data associated with a second TRP in the two TRPs, that is, in the transmission occasions of the uplink data, the RV of the transmission occasion associated with TRP #1 is related to the RV of the transmission occasion associated with TRP #2. Thus, the terminal equipment may use the relation therebetween to improve combined gains of the uplink data. This is because compared with a case where transmission occasions associated with different TRPs are not related, the RV of the transmission occasion associated with TRP #1 is related to the RV of the transmission occasion associated with TRP #2, so that in a scenario where the transmission occasion associated with TRP #1 and the transmission occasion associated with TRP #2 are neighboring in a time domain and a probability of blockage is relatively low (that is, it is very probable that neighbored transmission occasions associated with TRP #1 and associated with TRP #2 may be received at the same time), higher combined gains may be achieved by optimizing corresponding RVs.

In some embodiments, a sequence number related to the first transmission occasion is identical to a sequence number related to the second transmission occasion. Here, the sequence numbers are sequence numbers corresponding to the transmission occasions.

In some embodiments, that the RV of the first transmission occasion of the uplink data is related to the RV of the second transmission occasion of the uplink data refers to that, a difference between the RV of the first transmission occasion and the RV of the second transmission occasion is indicated by RRC signaling. Hence, a network device may semi-statically adjust the RV of the transmission occasion of the PUSCH corresponding to TRP #2 via the RRC signaling according to an actual situation, so as to improve combined gains of corresponding uplink data signals, and thus improve the system performance accordingly.

In the above embodiments, the difference may be an offset, such as rvₛ shown in FIGS. 13 and 14, or may be a shift, such as RV shift shown in FIG. 15.

In some embodiments, that the RV of the first transmission occasion of the uplink data is related to the RV of the second transmission occasion of the uplink data refers to that, a difference between the RV of the first transmission occasion and the RV of the second transmission occasion is indicated by DCI signaling. Thus, the network device may flexibly indicate a corresponding RV according to each time of transmission of the PUSCH.

In the above embodiments, it is applicable to a dynamically scheduled PUSCH, such as the scenario shown in FIG. 13.

For example, the above difference is indicated by a corresponding unit of a TDRA field of the above DCI signaling. Therefore, it is not needed to add extra DCI fields, which is beneficial to reduce a size of the DCI, thereby improving reliability of a control channel.

For another example, the above difference is indicated by a field of the DCI signaling. As a result, it is relatively simple, with low implementation difficulty and cost, and little impact is imposed on standardization.

In some embodiments, that the RV of the first transmission occasion of the uplink data is related to the RV of the second transmission occasion of the uplink data refers to that, the RV of the first transmission occasion and the RV of the second transmission occasion are identical. In this method, no extra indications are needed, indication overhead is saved, and furthermore, this method is simple, and hardware implementation is facilitated.

In some embodiments, that the RV of the first transmission occasion of the uplink data is related to the RV of the second transmission occasion of the uplink data refers to that, a difference between the RV of the first transmission occasion and the RV of the second transmission occasion is determined according to a third transmission occasion; wherein the third transmission occasion refers to a last transmission occasion before the second transmission occasion associated with the first TRP in the two TRPs. Similarly, in this method, no extra indications are needed, indication overhead is saved, and furthermore, in this method, when a probability of blockage is relatively low (that is, it is very probable that neighbored transmission occasions associated with TRP #1 and associated with TRP #2 may be received at the same time), higher combined gains may be achieved by specifying a relation between RVs of neighboring transmission occasions.

In the embodiments of this disclosure, in some embodiments, as shown in FIG. 12, the method may further include:

1202: the terminal equipment receives indication information; wherein the indication information indicates the RV of the transmission occasion of the uplink data associated with the first TRP in the two TRPs, and the indication information is contained in DCI signaling or RRC signaling.

According to the above embodiment, the terminal equipment may learn the RV of the transmission occasion of the PUSCH associated with the first TRP (TRP #1) in the two TRPs, and on this basis, the terminal equipment may determine the RV of the transmission occasion associated with the second TRP (TRP #2) in the two TRPs.

For example, in the previous embodiment, the RV of the transmission occasion associated with TRP #1 is related to the RV of the transmission occasion associated with TRP #2, and the terminal equipment may use the correlation therebetween to determine the RV of the transmission occasion associated with TRP #2 based on the above received indication information according to the RV of the transmission occasion associated with TRP #1. Meanings of the correlation therebetween have been described above, and contents of which are incorporated herein, which shall not be described herein any further.

The above indications shall be described below by taking FIG. 13 as an example.

As shown in FIG. 13, for the case where the difference between the RV of the first transmission occasion and the RV of the second transmission occasion is indicated by the DCI signaling (dynamically indicated), in some embodiments, rv_{id} is indicated respectively by scheduling DCI (an RV field) corresponding to the PUSCH, and rvₛ is dynamically indicated by the DCI. More specifically, for example, rvₛ is indicated by a field of the DCI. In the example of FIG. 13, rvₛ=1.

Table 22 below shows an RV sequence applied by an n-th transmission occasion associated with TRP #1, or Table 32 shows an RV of an n-th transmission occasion associated with TRP #1. Table 23 below shows an RV sequence applied by an n-th transmission occasion associated with TRP #2, or Table 33 shows an RV of an n-th transmission occasion associated with TRP #2. It should be noted that in the example shown in FIG. 13, n=0,1,2 . . . ; for example, a 0-th transmission occasion associated with TRP #1 is Rep #1, and a 0-th transmission occasion associated with TRP #2 is Rep #2.

TABLE 22

| rv_{id} indicated | RV to be applied to n^{th} transmission | | | |
|---|---|---|---|---|
| by the DCI | occasion associated with TRP#1 | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 23

| rv_{id} indicated | RV to be applied to n^{th} transmission | | | |
|---|---|---|---|---|
| by the DCI | occasion associated with TRP#2 | | | |
| scheduling | n mod | n mod | n mod | n mod |
| the PUSCH | 4 = 0 | 4 = 1 | 4 = 2 | 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 13 that when the DCI scheduling the PUSCH indicates that rv_{id}=0, according to Table 22, the RV sequence applied by the 0-th transmission occasion associated with TRP #1 is 0. As rvₛ=1 in this example, according to Table 23, the RV applied by the 0-th transmission occasion associated with TRP #2 is 1. In addition, an RV sequence applied by the transmission occasions associated with TRP #1 is {0,2,3,1}, and an RV sequence applied by the transmission occasions associated with TRP #2 is {0,2,3,1}.

As shown in FIG. 13, for the case where the RV of the first transmission occasion is identical to the RV of the second transmission occasion (default #1), in some embodiments, rv_{id} is indicated by the scheduling DCI (an RV field) corresponding to the PUSCH. That is, for the uplink data, the RV of the n-th transmission occasion associated with TRP #1 is identical to the RV of the n-th transmission occasion associated with TRP #2.

Table 24 below shows the RV applied by the n-th transmission occasion associated with TRP #1 or TRP #2.

TABLE 24

| | RV to be applied to n^{th} transmission | | | |
|---|---|---|---|---|
| rv_{id} indicated | occasion associated with | | | |
| by the DCI | TRP#1 or TRP#2 | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

It can be seen from FIG. 13 that when the DCI scheduling the PUSCH indicates that rv_{id}=0, according to Table 24, the RV applied by the 0-th transmission occasion associated with TRP #1 is identical to the RV applied by the 0-th transmission occasion associated with TRP #2, both of which are 0. In addition, the RV sequence applied by the transmission occasion associated with TRP #1 is {0,2,3,1}, and the RV sequence applied by the transmission occasion associated with TRP #2 is also {0,2,3,1}.

As shown in FIG. 13, for the case where the difference between the RV of the first transmission occasion and the RV of the second transmission occasion is determined according to the third transmission occasion (default #2), in some embodiments, rv_{id} is indicated by the scheduling DCI (an RV field) corresponding to the PUSCH. And rvₛ is determined by a transmission occasion associated with TRP #1 before the second transmission occasion.

For example, in FIG. 13, for the second transmission occasion with a sequence number of 0 (i.e. n=0), before the second transmission occasion, according to FIG. 13, an RV of the transmission occasion (the third transmission occasion) corresponding to TRP #1 is 0, and an RV next to the RV of the 0-th transmission occasion associated with TRP #2 that is 0 is 2 (according to an order of 0-2-3-1), thus, rvₛ=2-0=2. And RVs of other transmission occasions may be calculated according to rvₛ=2. Furthermore, an RV sequence applied by the transmission occasion associated with TRP #1 is {0,2,3,1}, and the RV sequence applied by the transmission occasion associated with TRP #2 is {0,2,3,1}.

Table 25 below shows the RV applied by the n-th transmission occasion associated with TRP #1, and Table 26 below shows the RV applied by the n-th transmission occasion associated with TRP #2.

TABLE 25

| rv_{id} indicated | RV to be applied to n^{th} transmission | | | |
|---|---|---|---|---|
| by the DCI | occasion associated with TRP#1 | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 26

| rv_{id} indicated | RV to be applied to n^{th} transmission | | | |
|---|---|---|---|---|
| by the DCI | occasion associated with TRP#2 | | | |
| scheduling | n mod | n mod | n mod | n mod |
| the PUSCH | 4 = 0 | 4 = 1 | 4 = 2 | 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 13 that when the DCI scheduling the PUSCH indicates that rv_{id}=0, according to Table 25, the RV applied by the 0-th transmission occasion associated with TRP #1 is 0. As rvₛ=2 in this example, according to Table 26, the RV applied by the 0-th transmission occasion associated with TRP #2 is 2. In addition, the RV sequence applied by the transmission occasion associated with TRP #1 is {0,2,3,1}, and the RV sequence applied by the transmission occasion associated with TRP #2 is {0,2,3,1}.

As shown in FIG. 13, for the case where the difference between the RV of the first transmission occasion and the RV of the second transmission occasion is indicated by the RRC signaling (RRC configured), in some embodiments, rv_{id} is indicated by scheduling DCI (an RV field) corresponding to the PUSCH, and rvₛ is configured by the RRC signaling. In the example of FIG. 13, rvₛ=2.

Table 27 below shows an RV applied by the n-th transmission occasion associated with TRP #1, and Table 28 below shows an RV applied by the n-th transmission occasion associated with TRP #2.

TABLE 27

| rv_{id} indicated | RV to be applied to n^{th} transmission | | | |
|---|---|---|---|---|
| by the DCI | occasion associated with TRP#1 | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 28

| rv_{id} indicated | RV to be applied to n^{th} transmission | | | |
|---|---|---|---|---|
| by the DCI | occasion associated with TRP#2 | | | |
| scheduling | n mod | n mod | n mod | n mod |
| the PUSCH | 4 = 0 | 4 = 1 | 4 = 2 | 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

It can be seen from FIG. 13 that when the DCI scheduling the PUSCH indicates that rv_{id}=0, according to Table 27, the RV applied by the 0-th transmission occasion associated with TRP #1 is 0. As rvₛ=2 in this example, according to Table 28, an RV applied by the 0-th transmission occasion associated with TRP #2 is 2. In addition, an RV sequence applied by the transmission occasion associated with TRP #1 is {0,2,3,1}, and an RV sequence applied by the transmission occasion associated with TRP #2 is {0,2,3,1}.

The above indications shall be described below by taking FIG. 14 as an example.

As shown in FIG. 14, for the case where the RV of the first transmission occasion is identical to the RV of the second transmission occasion (default #1), in some embodiments, the RVs may be determined according to Table 29 below. That is, for the uplink data, the RV of the n-th transmission occasion associated with TRP #1 is identical to the RV of the n-th transmission occasion associated with TRP #2.

Table 29 below shows the RV applied by the n-th transmission occasion associated with TRP #1 or TRP #2.

TABLE 29
RV to be applied to n^{th} transmission occasion
associated with TRP#1 or TRP#2

| n mod | n mod | n mod | n mod |
|---|---|---|---|
| 4 = 0 | 4 = 1 | 4 = 2 | 4 = 3 |
| 0 | 2 | 3 | 1 |

It can be seen from FIG. 14 that the RV applied by the 0-th transmission occasion associated with TRP #1 is identical to the RV applied by the 0-th transmission occasion associated with TRP #2, both of which are 0. In addition, the RV sequence applied by the transmission occasion associated with TRP #1 is {0,2,3,1}, and the RV sequence applied by the transmission occasion associated with TRP #2 is also {0,2,3,1}.

As shown in FIG. 14, for the case where the difference between the RV of the first transmission occasion and the RV of the second transmission occasion is determined according to the third transmission occasion (default #2), in some embodiments, the RVs may be determined according to tables 40 and 41 below. And rvₛ is determined by a transmission occasion associated with TRP #1 before the second transmission occasion.

For example, in FIG. 14, for the second transmission occasion with a sequence number of 0 (i.e. n=0), before the second transmission occasion, according to FIG. 14, an RV of the transmission occasion (the third transmission occasion) corresponding to TRP #1 is 0, and an RV next to the RV of the 0-th transmission occasion associated with TRP #2 that is 0 is 2 (according to an order of 0-2-3-1), thus, rvₛ=2-0=2. And RVs of other transmission occasions may be calculated according to rvₛ=2. Furthermore, an RV sequence applied by the transmission occasion associated with TRP #1 is {0,2,3,1}, and the RV sequence applied by the transmission occasion associated with TRP #2 is {0,2,3,1}.

Table 30 below shows the RV applied by the n-th transmission occasion associated with TRP #1, and Table 31 below shows the RV applied by the n-th transmission occasion associated with TRP #2.

TABLE 30
RV to be applied to n^{th} transmission
occasion associated with TRP#1

| n mod | n mod | n mod | n mod |
|---|---|---|---|
| 4 = 0 | 4 = 1 | 4 = 2 | 4 = 3 |
| 0 | 2 | 3 | 1 |

TABLE 31
RV to be applied to n^{th} transmission
occasion associated with TRP#2

| n mod | n mod | n mod | n mod |
|---|---|---|---|
| 4 = 0 | 4 = 1 | 4 = 2 | 4 = 3 |
| (0 + rvₛ) | (2 + rvₛ) | (3 + rvₛ) | (1 + rvₛ) |
| mod 4 | mod 4 | mod 4 | mod 4 |

It can be seen from FIG. 14 that according to Table 30, the RV applied by the 0-th transmission occasion associated with TRP #1 is 0. As rvₛ=2 in this example, according to Table 31, the RV applied by the 0-th transmission occasion associated with TRP #2 is 2. In addition, the RV sequence applied by the transmission occasion associated with TRP #1 is {0,2,3,1}, and the RV sequence applied by the transmission occasion associated with TRP #2 is {0,2,3,1}.

As shown in FIG. 14, for the case where the difference between the RV of the first transmission occasion and the RV of the second transmission occasion is indicated by the RRC signaling (RRC configured), in some embodiments, the RVs may be determined according to tables 32 and 33 below, wherein, rvₛ is configured by the RRC signaling. In the example of FIG. 14, rvₛ=2.

Table 32 below shows an RV applied by the n-th transmission occasion associated with TRP #1, and Table 33 below shows an RV applied by the n-th transmission occasion associated with TRP #2.

TABLE 32
RV to be applied to n^{th} transmission
occasion associated with TRP#1

| n mod | n mod | n mod | n mod |
|---|---|---|---|
| 4 = 0 | 4 = 1 | 4 = 2 | 4 = 3 |
| 0 | 2 | 3 | 1 |

TABLE 33
RV to be applied to n^{th} transmission
occasion associated with TRP#2

| n mod | n mod | n mod | n mod |
|---|---|---|---|
| 4 = 0 | 4 = 1 | 4 = 2 | 4 = 3 |
| (0 + rvₛ) | (2 + rvₛ) | (3 + rvₛ) | (1 + rvₛ) |
| mod 4 | mod 4 | mod 4 | mod 4 |

It can be seen from FIG. 14 that according to Table 32, the RV applied by the 0-th transmission occasion associated with TRP #1 is 0. As rvₛ=2 in this example, according to Table 33, an RV applied by the 0-th transmission occasion associated with TRP #2 is 2. In addition, an RV sequence applied by the transmission occasion associated with TRP #1 is {0,2,3,1}, and an RV sequence applied by the transmission occasion associated with TRP #2 is {0,2,3,1}.

The above indications shall be described below by taking FIG. 15 as an example.

As shown in FIG. 15, for the case where the RV of the first transmission occasion is identical to the RV of the second transmission occasion (default #1), in some embodiments, the RVs may be determined according to Table 34, that is, for the uplink data, the RV of the n-th transmission occasion associated with TRP #1 is identical to the RV of the n-th transmission occasion associated with TRP #2.

Table 34 below shows the RV applied by the n-th transmission occasion associated with TRP #1 or TRP #2.

TABLE 34
RV to be applied to n^{th} transmission occasion
associated with TRP#1 or TRP#2

| n mod | n mod | n mod | n mod |
|---|---|---|---|
| 4 = 0 | 4 = 1 | 4 = 2 | 4 = 3 |
| 0 | 3 | 0 | 3 |

It can be seen from FIG. 15 that according to Table 34, the RV applied by the 0-th transmission occasion associated with TRP #1 is identical to the RV applied by the 0-th transmission occasion associated with TRP #2, both of which are 0. In addition, the RV sequence applied by the transmission occasion associated with TRP #1 is {0,3,0,3}, and the RV sequence applied by the transmission occasion associated with TRP #2 is also {0,3,0,3}.

As shown in FIG. 15, for the case where the difference between the RV of the first transmission occasion and the RV of the second transmission occasion is determined according to the third transmission occasion (default #2), in some embodiments, the RVs may be determined according to tables 35 and 36 below, wherein, RVshift is determined by the transmission occasion associated with TRP #1 before the second transmission occasion.

For example, in FIG. 15, for the second transmission occasion with a sequence number of 0 (i.e. n=0), before the second transmission occasion, according to FIG. 15, an RV of the transmission occasion (the third transmission occasion) corresponding to TRP #1 is 0, and an RV next to the RV of the 0-th transmission occasion associated with TRP #2 that is 0 is 3 (according to an order of 0-3-0-3), thus, RVshift=1. And RVs of other transmission occasions may be calculated according to RVshift=1. Furthermore, an RV sequence applied by the transmission occasion associated with TRP #1 is {0,3,0,3}, and the RV sequence applied by the transmission occasion associated with TRP #2 is {0,3,0,3}.

Table 35 below shows the RV applied by the n-th transmission occasion associated with TRP #1, and Table 36 below shows the RV applied by the n-th transmission occasion associated with TRP #2.

TABLE 35
RV to be applied to n^{th} transmission
occasion associated with TRP#1

| n mod | n mod | n mod | n mod |
|---|---|---|---|
| 4 = 0 | 4 = 1 | 4 = 2 | 4 = 3 |
| 0 | 3 | 0 | 3 |

TABLE 36

| | RV to be applied to n^{th} transmission | | | |
|---|---|---|---|---|
| | occasion associated with TRP#2 | | | |
| | n mod | n mod | n mod | n mod |
| RVshift | 4 = 0 | 4 = 1 | 4 = 2 | 4 = 3 |
| 0 | 0 | 3 | 0 | 3 |
| 1 | 3 | 0 | 3 | 0 |

It can be seen from FIG. 15 that according to Table 35, the RV applied by the 0-th transmission occasion associated with TRP #1 is 0. As RVshift=1 in this example, according to Table 36, the RV applied by the 0-th transmission occasion associated with TRP #2 is 3. In addition, an RV sequence applied by the transmission occasion associated with TRP #1 is {0,3,0,3}, and an RV sequence applied by the transmission occasion associated with TRP #2 is {0,3,0,3}.

As shown in FIG. 15, for the case where the difference between the RV of the first transmission occasion and the RV of the second transmission occasion is indicated by the RRC signaling (RRC configured), in some embodiments, the RVs may be determined according to tables 37 and 38 below, wherein RVshift is configured by RRC signaling. In the example of FIG. 15, RVshift=1.

Table 37 below shows the RV applied by the n-th transmission occasion associated with TRP #1, and Table 38 below shows the RV applied by the n-th transmission occasion associated with TRP #2.

TABLE 37
RV to be applied to n^{th} transmission
occasion associated with TRP#1

| n mod | n mod | n mod | n mod |
|---|---|---|---|
| 4 = 0 | 4 = 1 | 4 = 2 | 4 = 3 |
| 0 | 3 | 0 | 3 |

TABLE 38

| | RV to be applied to n^{th} transmission | | | |
|---|---|---|---|---|
| | occasion associated with TRP#2 | | | |
| | n mod | n mod | n mod | n mod |
| RVshift | 4 = 0 | 4 = 1 | 4 = 2 | 4 = 3 |
| 0 | 0 | 3 | 0 | 3 |
| 1 | 3 | 0 | 3 | 0 |

It can be seen from FIG. 15 that according to Table 37, the RV applied by the 0-th transmission occasion associated with TRP #1 is 0. As RVshift=1 in this example, according to Table 38, the RV applied by the 0-th transmission occasion associated with TRP #2 is 3. In addition, an RV sequence applied by the transmission occasion associated with TRP #1 is {0,3,0,3}, and an RV sequence applied by the transmission occasion associated with TRP #2 is {0,3,0,3}.

The above indications shall be described below by taking FIG. 16 as an example.

As shown in FIG. 16, the RV sequence applied by the transmission occasion associated with TRP #1 is {0,0,0,0}, and the RV sequence applied by the transmission occasion associated with TRP #2 is also {0,0,0,0}. That is, RVs of the transmission occasions of the uplink data are all 0. It should be noted that in the example shown in FIG. 16, n=0, 1, 2, . . . ; for example, a second transmission occasion associated with TRP #1 is Rep #1, and a first transmission occasion associated with TRP #2 is Rep #2.

In the above embodiments, in some embodiments, the RV sequence applied by the transmission occasion in the at least two transmission occasions of the uplink data associated with the first TRP in the above two TRPs is identical to the RV sequence applied by the transmission occasion in the at least two transmission occasions of the uplink data associated with the second TRP in the above two TRPs. Therefore, multiple TRPs may share identical RV sequences, thereby saving signaling overhead.

In the embodiments of this disclosure, in some embodiments, the uplink data start from the transmission occasion associated with the first TRP (TRP #1) in the two TRPs and with a corresponding RV of 0. Therefore, the terminal equipment is only allowed to transmit PUSCH transmission at a transmission occasion with relatively high reliability, this is advantageous for in case of a large CG, the network device needs only to assume that PUSCH transmission may occur on a part of PUSCH transmission occasions. In this way, the number of times of blind detection at the network side may be reduced, and the design complexity at the network side may be lowered.

Taking FIG. 15 as an example, the PUSCH starts only from some PUSCH transmission occasions. That is, if a configured RV sequence is {0,3,0,3}, initial transmission of a transmission block of the configured grant may start from any transmission occasion associated with TRP #1 and with RV=0.

As shown in FIG. 15, as RV=0, the PUSCH may be transmitted starting from the 0-th transmission occasion (Rep #1).

Taking FIG. 16 as an example, the PUSCH starts only from some PUSCH transmission occasions. That is, if a configured RV sequence is {0,0,0,0}, the initial transmission of the transmission block of the configured grant may start from any transmission occasion associated with TRP #1 and with RV=0.

As shown in FIG. 16, as RV=0, the PUSCH may be transmitted starting from a 0-th or a second transmission occasion (Rep #1 or Rep #3).

In the embodiments of this disclosure, in some embodiments, that the at least one transmission occasion of the uplink data is associated with two TRPs refers to that,

the at least one transmission occasion of the uplink data is respectively related (mapped) to the two TRPs in unit of at least one slot; or

the at least one transmission occasion of the uplink data is respectively related (mapped) to the two TRPs in unit of at least one time domain portion in a slot.

Specific implementations are not limited in the embodiments of this disclosure.

In the embodiment of this disclosure, the TRP is equivalent to at least one of the following concepts:

a transmission configuration indication (TCI) state;

a spatial relation;

a reference signal;

a reference signal group;

an SRS resource group (containing one or more SRS resources);

a spatial domain filter;

a power control parameter; and

a group of time alignment (TA) related parameters.

Reference may be made to relevant technologies for specific meanings of the above concepts, which shall not be repeated herein any further.

For example, that the at least one transmission occasion of the PUSCH is associated with at least two TRPs is equivalent to that, the at least one transmission occasion of the PUSCH is associated with at least two TCI states, that is, the terminal equipment transmits the PUSCH according to parameters corresponding to the above at least two TCI states.

For another example, that the at least one transmission occasion of the PUSCH is associated with at least two TRPs is equivalent to that, the at least one transmission occasion of the PUSCH is associated with at least two spatial relations.

For a further example, that the at least one transmission occasion of the PUSCH is associated with at least two TRPs is equivalent to that, the at least one transmission occasion of the PUSCH is associated with at least two reference signals. Here, the reference signals may be pathloss reference signals (RSs), or CSI-RSs (channel state information reference signals), SSBs (synchronization signal blocks), SRSs (sounding reference signals), etc.; however, this disclosure is not limited thereto.

For still another example, that the at least one transmission occasion of the PUSCH is associated with at least two TRPs is equivalent to that, the at least one transmission occasion of the PUSCH is associated with at least two reference signal groups. A reference signal group is one or more reference signals (RSs). Here, the reference signal may be a pathloss reference signal (RS), or a CSI-RS (channel state information reference signal), an SSB (synchronization signal block), an SRS (sounding reference signal), etc.; however, this disclosure is not limited thereto.

For yet another example, that the at least one transmission occasion of the PUSCH is associated with at least two TRPs is equivalent to that, the at least one transmission occasion of the PUSCH is associated with at least two spatial filters.

For yet still another example, that the at least one transmission occasion of the PUSCH is associated with at least two TRPs is equivalent to that, the at least one transmission occasion of the PUSCH is associated with at least two power control parameters.

It should be noted that FIG. 12 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 12.

According to the method of the embodiment of this disclosure, it may be ensured that in case of blockage, even if only a part of TRPs may operate, compared with a case where the RV is unrelated to TRPs, there may have higher combined gains. This is because this method enables an RV of a transmission occasion of the above uplink data to be adjusted according to information on the TRPs, that is, in a case where TRPs corresponding to the transmission occasions of the uplink data are different, or when a probability that corresponding TRPs are blocked changes, an RV of each transmission occasion may be optimally determined according to the information on the TRPs, thereby improving performances of the system.

### Embodiment of a Third Aspect

The embodiment of this disclosure provides a method for transmitting uplink data, which shall be described from a terminal equipment side.

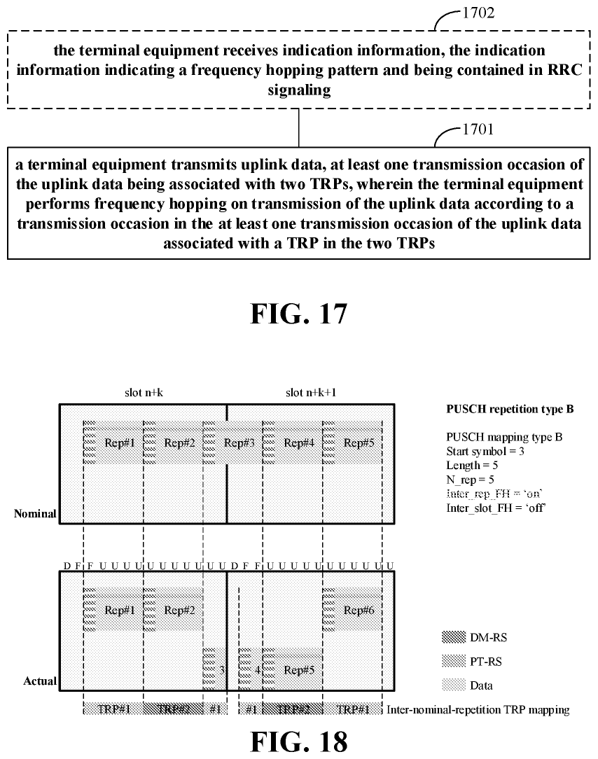

FIG. 17 is a schematic diagram of the method for transmitting uplink data of the embodiment of this disclosure, as shown in FIG. 17, the method includes:

1701: a terminal equipment transmits uplink data, at least one transmission occasion of the uplink data being associated with two TRPs, wherein the terminal equipment performs frequency hopping on transmission of the uplink data according to a transmission occasion in the at least one transmission occasion of the uplink data associated with a TRP in the two TRPs.

According to the method of the embodiment of this disclosure, it may be ensured that in case of blockage, even if only a part of TRPs may operate, compared with a case where the frequency hopping of the uplink data is unrelated to the TRPs, frequency domain diversity gains may be better utilized. This is because this method enables the frequency hopping pattern of the transmission occasions of the above uplink data to be adjusted according to information on the TRPs, that is, in a case where TRPs corresponding to the transmission occasions of the uplink data are different, or when a probability that corresponding TRPs are blocked changes, a frequency hopping pattern of each transmission occasion may be optimally determined according to the information on the TRPs, thereby increasing frequency domain diversity gains and improving performances of the system.

In some embodiments, the transmission occasion in at least one transmission occasion of the uplink data associated with a TRP in the two TRPs refers to:

for uplink data transmitted in a manner of PUSCH repetition type B, a transmission occasion of a nominal repetition in the at least one transmission occasion of the uplink data associated with a TRP in the two TRPs; or

for uplink data transmitted in a manner of PUSCH repetition type B, a transmission occasion of an actual repetition in the at least one transmission occasion of the uplink data associated with a TRP in the two TRPs; or

for uplink data transmitted in a manner of PUSCH repetition type A, a transmission occasion in the at least one transmission occasion of the uplink data in at least one slot associated with a TRP in the two TRPs.

In some embodiments, the performing frequency hopping refers to performing frequency hopping according to the nominal repetition of the uplink data. That is, for uplink data transmitted in the manner of PUSCH repetition type B, frequency hopping is performed according to a nominal repetition or a transmission occasion of a nominal repetition of the uplink data.

In some embodiments, the performing frequency hopping refers to performing frequency hopping according to the actual repetition of the uplink data. That is, for uplink data transmitted in the manner of PUSCH repetition type B, frequency hopping is performed according to an actual repetition or a transmission occasion of an actual repetition of the uplink data.

In some embodiments, the performing frequency hopping refers to performing frequency hopping according to a slot where the uplink data are located. That is, for uplink data transmitted in the manner of PUSCH repetition type B or uplink data transmitted in the manner of PUSCH repetition type A, frequency hopping is performed according to transmission occasions in one or more slots of the uplink data.

In some embodiments, the performing frequency hopping refers to performing frequency hopping according to a time domain portion corresponding to the uplink data within a slot where the uplink data are located. That is, for uplink data transmitted in the manner of PUSCH repetition type A, frequency hopping is performed according to the time domain portion corresponding to the uplink data, in the slot where the uplink data are located.

FIG. 18 is a schematic diagram of an example of a mapping relation between a dynamically scheduled or configured grant PUSCH and a frequency hopping pattern, the example in FIG. 18 corresponding to the uplink data transmitted in the manner of PUSCH repetition type B.

As shown in FIG. 18, a frequency hopping pattern corresponding to TRP #1 is identical to a frequency hopping pattern corresponding to TRP #2. Specifically, frequency hopping occurs in the above uplink data in unit of the nominal repetition associated with TRP #1, that is, the frequency hopping pattern is inter-repetition frequency hopping, and the number of frequency hopping (or a candidate frequency domain position of frequency hopping) is 2; likewise, frequency hopping occurs in the above uplink data in unit of the nominal repetition associated with TRP #2, the frequency hopping pattern is also inter-repetition frequency hopping, and the number of frequency hopping (or a candidate frequency domain position of frequency hopping) is also 2.

In addition, a frequency domain position of a starting nominal repetition corresponding to TRP #1 is identical to a frequency domain position of a starting nominal repetition corresponding to TRP #2.

In addition, a frequency offset between two frequency hopping candidate positions corresponding to TRP #1 is identical to a frequency offset between two frequency hopping candidate positions corresponding to TRP #2.

In addition, that both TRP #1 and TRP #2 perform frequency hopping according to nominal repetitions refers to that, for example, frequency hopping is performed for nominal repetitions (Rep #1, Rep #3, Rep #5) corresponding to TRP #1 (corresponding to actual repetitions Rep #1, Rep #3, Rep #4, Rep #6), and frequency hopping is performed for nominal repetitions (Rep #2, Rep #4) corresponding to TRP #2 (corresponding to actual repetitions Rep #2, Rep #5).

In addition, a mapping method between the uplink data and the TRPs is inter-nominal-repetition TRP mapping, that is, the uplink data are sequentially mapped to different TRPs in units of nominal repetitions.

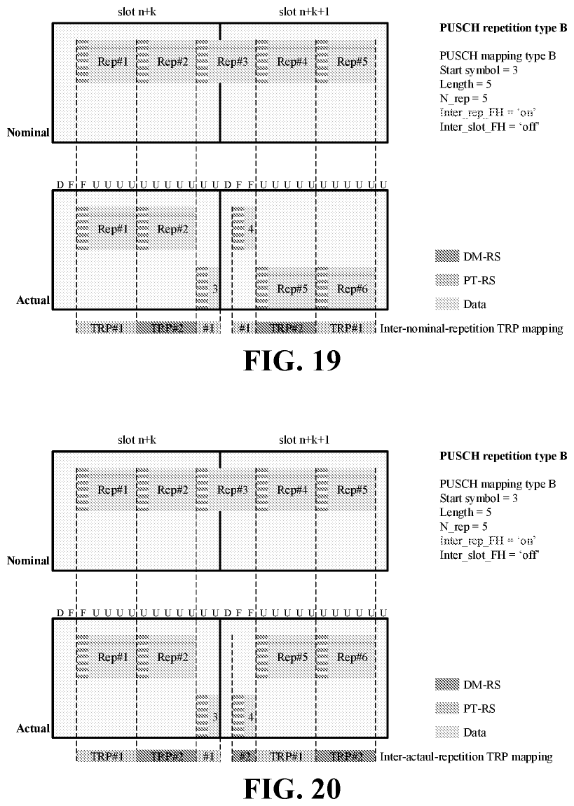

FIG. 19 is a schematic diagram of another example of the mapping relation between a dynamically scheduled or configured grant PUSCH and a frequency hopping pattern, the example of FIG. 19 corresponding to uplink data transmitted in the manner of PUSCH repetition type B.

As shown in FIG. 19, a frequency hopping pattern corresponding to TRP #1 is identical to a frequency hopping pattern corresponding to TRP #2. Specifically, frequency hopping occurs in the above uplink data in unit of the actual repetition associated with TRP #1, that is, the frequency hopping pattern is inter-repetition frequency hopping, and the number of frequency hopping (or a candidate frequency domain position of frequency hopping) is 2; likewise, frequency hopping occurs in the above uplink data in unit of the actual repetition associated with TRP #2, the frequency hopping pattern is also inter-repetition frequency hopping, and the number of frequency hopping (or a candidate frequency domain position of frequency hopping) is also 2.

In addition, a frequency domain position of a starting actual repetition corresponding to TRP #1 is identical to a frequency domain position of a starting actual repetition corresponding to TRP #2.

In addition, a frequency offset between two frequency hopping candidate positions corresponding to TRP #1 is identical to a frequency offset between two frequency hopping candidate positions corresponding to TRP #2.

In addition, that both TRP #1 and TRP #2 perform frequency hopping according to actual repetitions refers to that, for example, frequency hopping is performed for actual repetitions (Rep #1, Rep #3, Rep #4, Rep #6) corresponding to TRP #1, and frequency hopping is performed for actual repetitions (Rep #2, Rep #5) corresponding to TRP #2.

In addition, a mapping method between the uplink data and the TRPs is inter-nominal-repetition TRP mapping, that is, the uplink data are sequentially mapped to different TRPs in units of nominal repetitions.

FIG. 20 is a schematic diagram of a further example of the mapping relation between a dynamically scheduled or configured grant PUSCH and a frequency hopping pattern, the example of FIG. 20 corresponding to the uplink data transmitted in the manner of PUSCH repetition type B.

As shown in FIG. 20, a frequency hopping pattern corresponding to TRP #1 is identical to a frequency hopping pattern corresponding to TRP #2. Specifically, frequency hopping occurs in the above uplink data in unit of the nominal repetition associated with TRP #1, that is, the frequency hopping pattern is inter-repetition frequency hopping, and the number of frequency hopping (or a candidate frequency domain position of frequency hopping) is 2; likewise, frequency hopping occurs in the above uplink data in unit of the nominal repetition associated with TRP #2, the frequency hopping pattern is also inter-repetition frequency hopping, and the number of frequency hopping (or a candidate frequency domain position of frequency hopping) is also 2.

In addition, a frequency domain position of a starting nominal repetition corresponding to TRP #1 is identical to a frequency domain position of a starting nominal repetition corresponding to TRP #2.

In addition, a frequency offset between two frequency hopping candidate positions corresponding to TRP #1 is identical to a frequency offset between two frequency hopping candidate positions corresponding to TRP #2.

In addition, that both TRP #1 and TRP #2 perform frequency hopping according to actual repetitions refers to that, for example, frequency hopping is performed for actual repetitions (Rep #1, Rep #3, Rep #5) corresponding to TRP #1, and frequency hopping is performed for actual repetitions (Rep #2, Rep #4, Rep #6) corresponding to TRP #2.

In addition, a mapping method between the uplink data and the TRPs is inter-actual-repetition TRP mapping, that is, the uplink data are sequentially mapped to different TRPs in units of actual repetitions.

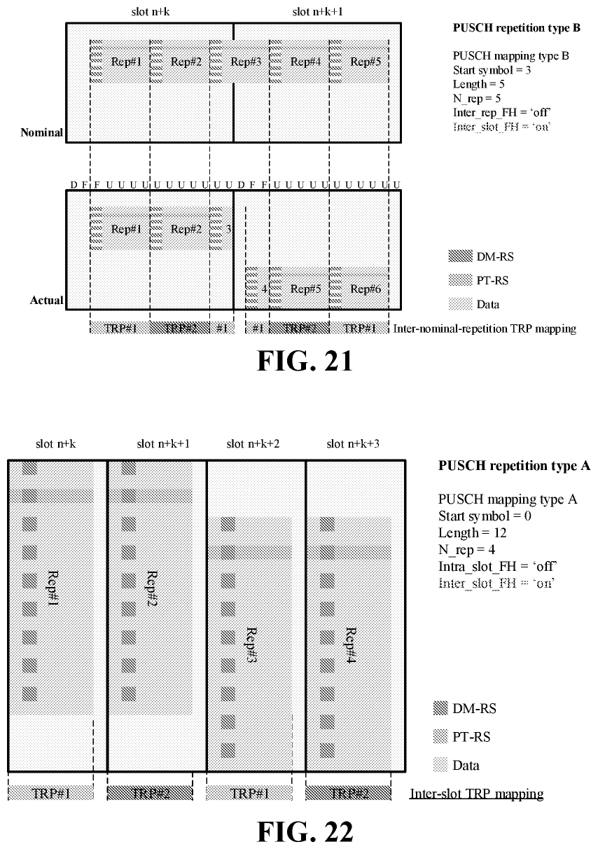

FIG. 21 is a schematic diagram of still another example of the mapping relation between a dynamically scheduled or configured grant PUSCH and a frequency hopping pattern, the example of FIG. 21 corresponding to the uplink data transmitted in the manner of PUSCH repetition type B.

As shown in FIG. 21, a frequency hopping pattern corresponding to TRP #1 is identical to a frequency hopping pattern corresponding to TRP #2. Specifically, frequency hopping occurs in the above uplink data in unit of slots associated with TRP #1, that is, the frequency hopping pattern is inter-slot frequency hopping, and the number of frequency hopping (or a candidate frequency domain position of frequency hopping) is 2; likewise, frequency hopping occurs in the above uplink data in unit of slots associated with TRP #2, the frequency hopping pattern is also inter-slot frequency hopping, and the number of frequency hopping (or a candidate frequency domain position of frequency hopping) is also 2.

In addition, a frequency domain position of a starting slot corresponding to TRP #1 is identical to a frequency domain position of a starting slot corresponding to TRP #2.

In addition, a frequency offset between two frequency hopping candidate positions corresponding to TRP #1 is identical to a frequency offset between two frequency hopping candidate positions corresponding to TRP #2.

In addition, that both TRP #1 and TRP #2 perform frequency hopping according to slots refers to that, for example, frequency hopping is performed for transmission occasions (Rep #1, Rep #3) within a slot n+k and transmission occasions (Rep #4, Rep #6) within a slot n+k+1 corresponding to TRP #1, and frequency hopping is performed for a transmission occasion (Rep #2) within a slot n+k and a transmission occasion (Rep #5) within a slot n+k+1 corresponding to TRP #2.

In addition, a mapping method between the uplink data and the TRPs is inter-nominal-repetition TRP mapping, that is, the uplink data are sequentially mapped to different TRPs in units of nominal repetitions.

FIG. 22 is a schematic diagram of an example of the mapping relation between a dynamically scheduled or configured grant PUSCH and a frequency hopping pattern, the example of FIG. 22 corresponding to the uplink data transmitted in the manner of PUSCH repetition type A.

As shown in FIG. 22, a frequency hopping pattern corresponding to TRP #1 is identical to a frequency hopping pattern corresponding to TRP #2. Specifically, frequency hopping occurs in the above uplink data in unit of slots associated with TRP #1, that is, the frequency hopping pattern is inter-slot frequency hopping, and the number of frequency hopping (or a candidate frequency domain position of frequency hopping) is 2; likewise, frequency hopping occurs in the above uplink data in unit of slots associated with TRP #2, the frequency hopping pattern is also inter-slot frequency hopping, and the number of frequency hopping (or a candidate frequency domain position of frequency hopping) is also 2.

In addition, a frequency domain position of a starting slot corresponding to TRP #1 is identical to a frequency domain position of a starting slot corresponding to TRP #2.

In addition, a frequency offset between two frequency hopping candidate positions corresponding to TRP #1 is identical to a frequency offset between two frequency hopping candidate positions corresponding to TRP #2.

In addition, that both TRP #1 and TRP #2 perform frequency hopping according to slots refers to that, for example, frequency hopping is performed for transmission occasions (Rep #1) within a slot n+k and transmission occasions (Rep #3) within a slot n+k+2 corresponding to TRP #1, and frequency hopping is performed for a transmission occasion (Rep #2) within a slot n+k+1 and a transmission occasion (Rep #4) within a slot n+k+3 corresponding to TRP #2.

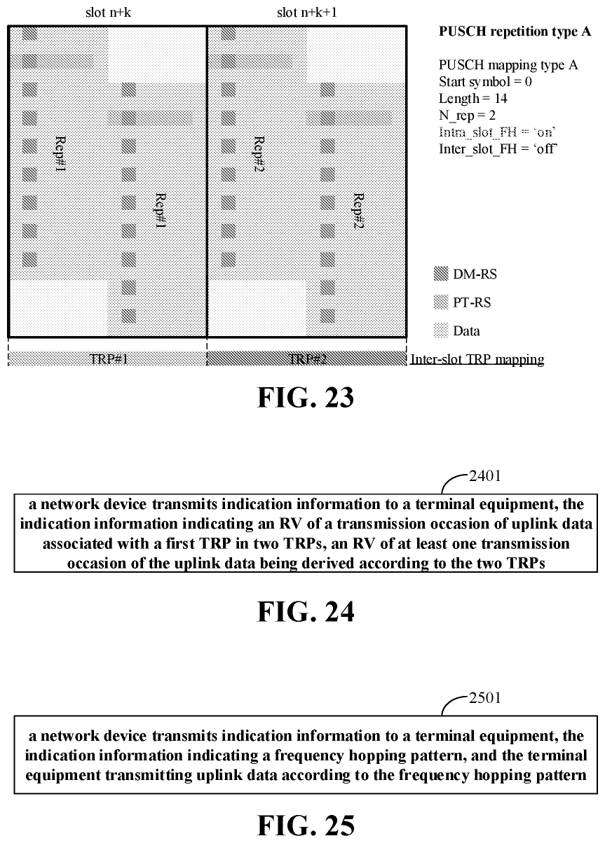

In addition, a mapping method between the uplink data and the TRPs is inter-slot-repetition TRP mapping, that is, the uplink data are sequentially mapped to different TRPs in units of slots. FIG. 23 is a schematic diagram of another example of the mapping relation between a dynamically scheduled or configured grant PUSCH and a frequency hopping pattern, the example of FIG. 23 corresponding to the uplink data transmitted in the manner of PUSCH repetition type A.

As shown in FIG. 23, a frequency hopping pattern corresponding to TRP #1 is identical to a frequency hopping pattern corresponding to TRP #2. Specifically, frequency hopping occurs in the above uplink data in unit of time domain portions in a slot associated with TRP #1, that is, the frequency hopping pattern is intra-slot frequency hopping, and the number of frequency hopping (or a candidate frequency domain position of frequency hopping) is 2; likewise, frequency hopping occurs in the above uplink data in unit of time domain portions in a slot associated with TRP #2, the frequency hopping pattern is also intra-slot frequency hopping, and the number of frequency hopping (or a candidate frequency domain position of frequency hopping) is also 2.

In addition, a frequency domain position of a starting time domain portion corresponding to TRP #1 is identical to a frequency domain position of a starting time domain portion corresponding to TRP #2.

In addition, a frequency offset between two frequency hopping candidate positions corresponding to TRP #1 is identical to a frequency offset between two frequency hopping candidate positions corresponding to TRP #2.

In addition, both TRP #1 and TRP #2 perform frequency hopping according to time domain portions in a slot. For example, frequency hopping is performed for a first time domain portion (first to seventh symbols in Rep #1) and a second time domain portion (eighth to fourteenth symbols in Rep #1) within a slot n+k corresponding to TRP #1, and frequency hopping is performed for a first time domain portion (first to seventh symbols in Rep #2) and a second time domain portion (eighth to fourteenth symbols in Rep #2) within a slot n+k+1 corresponding to TRP #2.

In addition, a mapping method between the uplink data and the TRPs is inter-slot-repetition TRP mapping, that is, the uplink data are sequentially mapped to different TRPs in units of slots.

In the embodiments of this disclosure, in some embodiments, as shown in FIG. 17, the method may further include:

1702: the terminal equipment receives indication information, the indication information indicating a frequency hopping pattern and being contained in RRC signaling.

According to the method of the above embodiment, the network device may semi-statically adjust the frequency hopping patterns corresponding to the TRPs related to the uplink data via the RRC signaling according to channel conditions, thereby improving performances of the system accordingly.

In some embodiments, the above indication information indicates the frequency hopping pattern of the uplink data associated with each of the two TRPs. That is, frequency hopping patterns are indicated according to each TRP. The advantage of this method is that the network device may semi-statically adjust the frequency hopping patterns corresponding to each TRP via the RRC signaling according to the channel conditions of each TRP, thereby improving performances of the system accordingly.

In some embodiments, the above indication information indicates the frequency hopping pattern of the uplink data associated with the first TRP in the two TRPs, and the frequency hopping patterns of the uplink data associated with the other TRP in the two TRPs are identical to the frequency hopping pattern of the uplink data associated with the first TRP. That is, the frequency hopping pattern of other TRP (TRP #2) is identical to the frequency hopping pattern of TRP #1 by default. The advantage of this method is that indication signaling may be reduced and overhead may be saved.

In the embodiment of this disclosure, the frequency hopping pattern includes at least one of the following:

whether to perform frequency hopping;

the number of hops;

a starting frequency domain position of frequency hopping; and

a frequency offset of frequency hopping.

In the embodiments of this disclosure, in some embodiments, a frequency hopping pattern applied by a transmission occasion in the at least one transmission occasion of the uplink data associated with the first TRP in the two TRPs is identical to a frequency hopping pattern applied by a transmission occasion in the at least one transmission occasion of the uplink data associated with the second TRP in the two TRPs. Therefore, multiple TRPs use identical frequency hopping patterns, which may save signaling overhead.

In the embodiments of this disclosure, in some embodiments, that at least one transmission occasion of the uplink data is associated with two TRPs refers that,

the at least one transmission occasion of the uplink data is respectively associated with the two TRPs in unit of a transmission occasion of at least one nominal repetition of the uplink data; or

the at least one transmission occasion of the uplink data is respectively associated with the two TRPs in unit of a transmission occasion of at least one actual repetition of the uplink data; or

the at least one transmission occasion of the uplink data is respectively associated with the two TRPs in unit of at least one slot.

Specific implementations are not limited in the embodiments of this disclosure.

In the embodiment of this disclosure, the TRP is equivalent to at least one of the following:

a transmission configuration indication (TCI) state;

a spatial relation;

a reference signal;

a reference signal group;

an SRS resource group (containing one or more SRS resources);

a spatial domain filter;

a power control parameter; and

a group of time alignment (TA) related parameters.

Reference may be made to relevant technologies for specific meanings of the above concepts, which shall not be repeated herein any further.

For example, that the at least one transmission occasion of the PUSCH is associated with at least two TRPs is equivalent to that, the at least one transmission occasion of the PUSCH is associated with at least two TCI states, that is, the terminal equipment transmits the PUSCH according to parameters corresponding to the above at least two TCI states.

For another example, that the at least one transmission occasion of the PUSCH is associated with at least two TRPs is equivalent to that, the at least one transmission occasion of the PUSCH is associated with at least two spatial relations.

For a further example, that the at least one transmission occasion of the PUSCH is associated with at least two TRPs is equivalent to that, the at least one transmission occasion of the PUSCH is associated with at least two reference signals. Here, the reference signals may be pathloss reference signals (RSs), or CSI-RSs (channel state information reference signals), SSBs (synchronization signal blocks), SRSs (sounding reference signals), etc.; however, this disclosure is not limited thereto.

For still another example, that the at least one transmission occasion of the PUSCH is associated with at least two TRPs is equivalent to that, the at least one transmission occasion of the PUSCH is associated with at least two reference signal groups. A reference signal group is one or more reference signals (RSs). Here, the reference signal may be a pathloss reference signal (RS), or a CSI-RS (channel state information reference signal), an SSB (synchronization signal block), an SRS (sounding reference signal), etc.; however, this disclosure is not limited thereto.

For yet another example, that the at least one transmission occasion of the PUSCH is associated with at least two TRPs is equivalent to that, the at least one transmission occasion of the PUSCH is associated with at least two spatial filters.

For yet still another example, that the at least one transmission occasion of the PUSCH is associated with at least two TRPs is equivalent to that, the at least one transmission occasion of the PUSCH is associated with at least two power control parameters.

It should be noted that FIG. 17 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 17.

According to the method of the embodiment of this disclosure, it may be ensured that in case of blockage, even if only a part of TRPs may operate, compared with a case where the frequency hopping of uplink data is unrelated to TRPs, frequency diversity gains may be used effectively. This is because this method enables a frequency hopping pattern of a transmission occasion of the above uplink data to be adjusted according to information on the TRPs, that is, in a case where TRPs corresponding to the transmission occasions of the uplink data are different, or when a probability that corresponding TRPs are blocked changes, a frequency hopping pattern of each transmission occasion may be optimally determined according to the information on the TRPs, thereby improving performances of the system.

### Embodiment of a Fourth Aspect

The embodiment of this disclosure provides a method for indicating uplink data transmission, which shall be described from a network side. This method is processing at a network side corresponding to the method of the embodiment of the first aspect or the second aspect, with contents identical to those in the embodiments of the first aspect and the second aspect being not going to be described herein any further.

FIG. 24 is a schematic diagram of the method for indicating uplink data transmission of the embodiment of this disclosure. As shown in FIG. 24, the method includes:

2401: a network device transmits indication information to a terminal equipment, the indication information indicating an RV of a transmission occasion of uplink data associated with a first TRP in two TRPs, an RV of at least one transmission occasion of the uplink data being derived according to the two TRPs.

In the above embodiment, the indication information may be contained in DCI signaling or RRC signaling, and specific contents of which have been described in the embodiments of the first and second aspects, which shall not be described herein any further.

The embodiment of this disclosure provides a method for indicating uplink data transmission, which shall be described from a network side. This method is processing at a network side corresponding to the method of the embodiment of the third aspect, with contents identical to those in the embodiment of the third aspect being not going to be described herein any further.

FIG. 25 is a schematic diagram of the method for indicating uplink data transmission of the embodiment of this disclosure. As shown in FIG. 25, the method includes:

2501: a network device transmits indication information to a terminal equipment, the indication information indicating a frequency hopping pattern, and the terminal equipment transmitting uplink data according to the frequency hopping pattern;

wherein at least one transmission occasion of the uplink data is associated with two TRPs, and the terminal equipment performs frequency hopping on transmission of the uplink data according to a transmission occasion of at least one transmission occasion of the uplink data associated with a TRP in the two TRPs.

In the above embodiment, specific contents of the indication information and the processing of the terminal equipment have been described in the third aspect of the embodiment, which shall not be repeated herein any further.

According to the method of the embodiment of this disclosure, frequency diversity gains may be increased, thereby improving performances of the system.

### Embodiment of a Fifth Aspect

The embodiment of this disclosure provides an apparatus for transmitting uplink data. The apparatus may be, for example, a terminal equipment, or may be one or more components or assemblies configured in a terminal equipment.

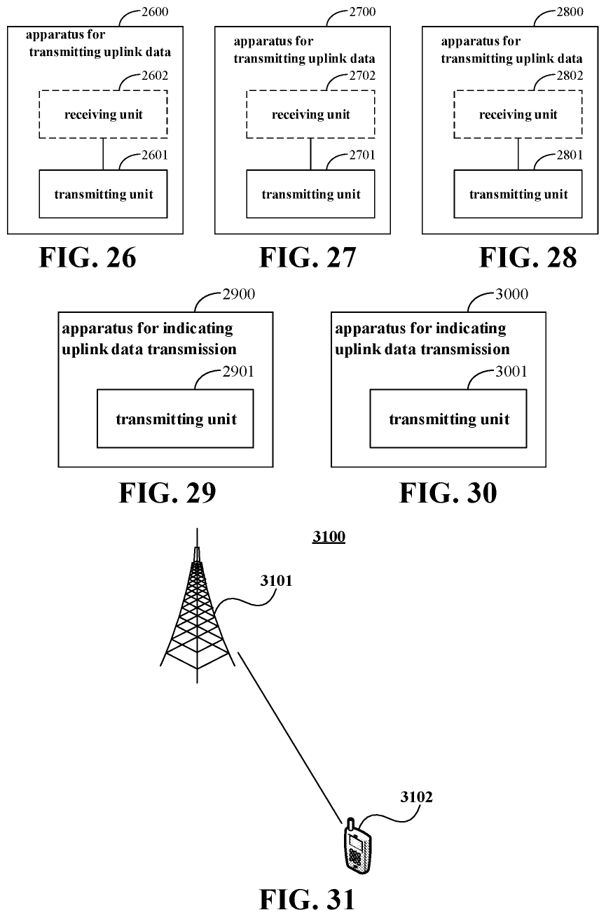

FIG. 26 is a schematic diagram of the apparatus for transmitting uplink data of the embodiment of this disclosure. As principles of the apparatus for solving problems are similar to the method of the embodiment of the first aspect, reference may be made to the implementation of the method of the embodiment of the first aspect for specific implementations of the apparatus, with identical contents being not going to be repeated herein any further.

As shown in FIG. 26, the apparatus 2600 for transmitting uplink data of the embodiment of this disclosure includes: a transmitting unit 2601 configured to transmit uplink data in a manner of PUSCH repetition type B, at least one transmission occasion of the uplink data being associated with two TRPs; wherein an RV of the at least one transmission occasion of the uplink data is derived according to the two TRPs.

In some embodiments, that the RV of the at least one transmission occasion of uplink data is derived according to the above two TRPs refers to that,

an RV of the transmission occasion of the actual repetition associated with the first TRP in the above two TRPs in the at least one transmission occasion of the uplink data is derived from a time domain order of the actual repetition, and

an RV of the transmission occasion of the actual repetition associated with the second TRP in the above two TRPs in the at least one transmission occasion of the uplink data is derived from the time domain order of the actual repetition.

In some embodiments, the RV of the at least one transmission occasion of the uplink data is derived according to the above two TRPs refers to that,

an RV of the transmission occasion of the nominal repetition associated with the first TRP in the above two TRPs in the at least one transmission occasion of the uplink data is derived from a time domain order of the nominal repetition, and

an RV of the transmission occasion of the nominal repetition associated with the second TRP in the above two TRPs in the at least one transmission occasion of the uplink data is derived from the time domain order of the nominal repetition.

In some embodiments, as shown in FIG. 26, the apparatus 2600 further includes:

a receiving unit 2602 configured to receive indication information; wherein the indication information indicates the RV of the transmission occasion of the uplink data associated with the first TRP in the two TRPs, and the indication information is contained in DCI signaling or RRC signaling.

In some embodiments, an RV of a first transmission occasion of the uplink data is related to an RV of a second transmission occasion of the uplink data, wherein the first transmission occasion is associated with the first TRP in the two TRPs, and the second transmission occasion is associated with the second TRP in the two TRPs.

In some embodiments, a sequence number related to the first transmission occasion is identical to a sequence number related to the second transmission occasion.

In some embodiments, that the RV of the first transmission occasion of the uplink data is related to the RV of the second transmission occasion of the uplink data refers to that, a difference (offset/shift) between the RV of the first transmission occasion and the RV of the second transmission occasion is indicated by RRC signaling.

In some embodiments, that the RV of the first transmission occasion of the uplink data is related to the RV of the second transmission occasion of the uplink data refers to that, a difference between the RV of the first transmission occasion and the RV of the second transmission occasion is indicated by DCI signaling.

In some embodiments, that the RV of the first transmission occasion of the uplink data is related to the RV of the second transmission occasion of the uplink data refers to that, the RV of the first transmission occasion and the RV of the second transmission occasion are identical.

In some embodiments, that the RV of the first transmission occasion of the uplink data is related to the RV of the second transmission occasion of the uplink data refers to that,

a difference between the RV of the first transmission occasion and the RV of the second transmission occasion is determined according to a third transmission occasion;

wherein the third transmission occasion refers to a last transmission occasion before the second transmission occasion associated with the first TRP in the two TRPs.

In some embodiments, the uplink data start from the transmission occasion of the actual repetition associated with the first TRP in the two TRPs and with a corresponding RV of 0.

In some embodiments, an RV sequence applied by the transmission occasion in the at least one transmission occasion of the uplink data associated with the first TRP in the two TRPs is identical to an RV sequence applied by the transmission occasion in the at least one transmission occasion of the uplink data associated with the second TRP in the two TRPs.

In some embodiments, that the at least one transmission occasion of the uplink data is associated with two TRPs refers to that,

the at least one transmission occasion of the uplink data is respectively associated with the two TRPs in unit of a transmission occasion of at least one nominal repetition of the uplink data;

the at least one transmission occasion of the uplink data is respectively associated with the two TRPs in unit of a transmission occasion of at least one actual repetition of the uplink data;

the at least one transmission occasion of the uplink data is respectively associated with the two TRPs in unit of at least one slot.

In some embodiments, the TRP is equivalent to at least one of the following:

a transmission configuration indication state;

a spatial relation;

a reference signal;

a reference signal group;

an SRS resource group;

a spatial domain filter;

a power control parameter; and

a group of time alignment (TA) related parameters.

It should be noted that the components or modules related to this disclosure are only described above. However, this disclosure is not limited thereto, and the apparatus 2600 for transmitting uplink data may further include other components or modules, and reference may be made to related techniques for particulars of these components or modules.

Furthermore, for the sake of simplicity, connection relationships between the components or modules or signal profiles thereof are only illustrated in FIG. 26. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

According to the embodiment of this disclosure, frequency diversity gains may be increased, thereby improving performances of the system.

### Embodiment of a Sixth Aspect

The embodiment of this disclosure provides an apparatus for transmitting uplink data. The apparatus may be, for example, a terminal equipment, or may be one or more components or assemblies configured in a terminal equipment.

FIG. 27 is a schematic diagram of the apparatus for transmitting uplink data of the embodiment of this disclosure. As principles of the apparatus for solving problems are similar to the method of the embodiment of the second aspect, reference may be made to the implementation of the method of the embodiment of the second aspect for specific implementations of the apparatus, with identical contents being not going to be repeated herein any further.

As shown in FIG. 27, the apparatus 2700 for transmitting uplink data of the embodiment of this disclosure includes: a transmitting unit 2701 configured to transmit uplink data in a manner of PUSCH repetition type A, at least one transmission occasion of the uplink data being associated with two TRPs; wherein an RV of at least one transmission occasion of the uplink data is derived according to the two TRPs.

In some embodiments, that an RV of at least one transmission occasion of the uplink data is derived according to the two TRPs refers to that,

an RV of a transmission occasion in the at least one transmission occasion of the uplink data associated with a first TRP in the two TRPs is derived from a time domain order of the transmission occasion associated with the first TRP,

and an RV of a transmission occasion in the at least one transmission occasion of the uplink data associated with a second TRP in the two TRPs is derived from a time domain order of the transmission occasion associated with the second TRP.

In some embodiments, as shown in FIG. 27, the apparatus 2700 further includes:

a receiving unit 2702 configured to receive indication information; wherein the indication information indicates the RV of the transmission occasion of the uplink data associated with the first TRP in the two TRPs, and the indication information is DCI signaling or RRC signaling.

In some embodiments, an RV of a first transmission occasion of the uplink data is related to an RV of a second transmission occasion of the uplink data, wherein the first transmission occasion is associated with the first TRP in the two TRPs, and the second transmission occasion is associated with the second TRP in the two TRPs.

In some embodiments, a sequence number related to the first transmission occasion is identical to a sequence number related to the second transmission occasion.

In some embodiments, that an RV of a first transmission occasion of the uplink data is related to an RV of a second transmission occasion of the uplink data refers to that,

a difference between the RV of the first transmission occasion and the RV of the second transmission occasion is indicated by RRC signaling.

In some embodiments, that an RV of a first transmission occasion of the uplink data is related to an RV of a second transmission occasion of the uplink data refers to that,

a difference between the RV of the first transmission occasion and the RV of the second transmission occasion is indicated by DCI signaling.

In some embodiments, that an RV of a first transmission occasion of the uplink data is related to an RV of a second transmission occasion of the uplink data refers to that,

the RV of the first transmission occasion is identical to the RV of the second transmission occasion.

In some embodiments, that the RV of the first transmission occasion of the uplink data is related to the RV of the second transmission occasion of the uplink data refers to that,

a difference between the RV of the first transmission occasion and the RV of the second transmission occasion is determined according to a third transmission occasion;

wherein the third transmission occasion refers to a last transmission occasion before the second transmission occasion associated with the first TRP in the two TRPs.

In some embodiments, the uplink data start from the transmission occasion associated with the first TRP in the two TRPs and with a corresponding RV of 0.

In some embodiments, the RV sequence applied by the transmission occasion in the at least two transmission occasions of the uplink data associated with the first TRP in the above two TRPs is identical to the RV sequence applied by the transmission occasion in the at least two transmission occasions of the uplink data associated with the second TRP in the above two TRPs.

In some embodiments, that the at least one transmission occasion of the uplink data is associated with two TRPs refers to one of the following that,

the at least one transmission occasion of the uplink data is respectively associated with the two TRPs in unit of at least one slot; and

the at least one transmission occasion of the uplink data is respectively associated with the two TRPs in unit of at least one time domain portion in a slot.

In some embodiments, the TRP is equivalent to at least one of the following:

a transmission configuration indication state;

a spatial relation;

a reference signal;

a reference signal group;

an SRS resource group;

a spatial domain filter;

a power control parameter; and

a group of time alignment (TA) related parameters.

According to the embodiment of this disclosure, frequency diversity gains may be increased, thereby improving performances of the system.

### Embodiment of a Seventh Aspect

The embodiment of this disclosure provides an apparatus for transmitting uplink data. The apparatus may be, for example, a terminal equipment, or may be one or more components or assemblies configured in a terminal equipment.

FIG. 28 is a schematic diagram of the apparatus for transmitting uplink data of the embodiment of this disclosure. As principles of the apparatus for solving problems are similar to the method of the embodiment of the third aspect, reference may be made to the implementation of the method of the embodiment of the third aspect for specific implementations of the apparatus, with identical contents being not going to be repeated herein any further.

As shown in FIG. 28, the apparatus 2800 for transmitting uplink data of the embodiment of this disclosure includes: a transmitting unit 2801 configured to transmit uplink data, at least one transmission occasion of the uplink data being associated with two TRPs, and the transmitting unit 2801 performs frequency hopping on transmission of the uplink data according to a transmission occasion in the at least one transmission occasion of the uplink data associated with a TRP in the two TRPs.

In some embodiments, the transmission occasion in the at least one transmission occasion of the uplink data associated with a TRP in the two TRPs refers to one of the following:

a transmission occasion of a nominal repetition in the at least one transmission occasion of the uplink data associated with a TRP in the two TRPs, wherein the uplink data are transmitted in a manner of PUSCH repetition type B;

a transmission occasion of an actual repetition in the at least one transmission occasion of the uplink data associated with a TRP in the two TRPs, wherein the uplink data are transmitted in a manner of PUSCH repetition type B;

a transmission occasion in the at least one transmission occasion of the uplink data in at least one slot associated with a TRP in the two TRPs, wherein the uplink data are transmitted in a manner of PUSCH repetition type A.

In some embodiments, the performing frequency hopping refers to performing frequency hopping according to a nominal repletion of the uplink data.

In some embodiments, the performing frequency hopping refers to performing frequency hopping according to an actual repletion of the uplink data.

In some embodiments, the performing frequency hopping refers to performing frequency hopping according to a slot where the uplink data are located.

In some embodiments, the performing frequency hopping refers to performing frequency hopping according to a time domain portion corresponding to the uplink data, in a slot where the uplink data are located.

In some embodiments, as shown in FIG. 28, the apparatus 2800 further includes:

a receiving unit 2802 configured to receive indication information; wherein the indication information indicates a frequency hopping pattern, and the indication information is contained in RRC signaling.

In some embodiments, the indication information indicates frequency hopping patterns of uplink data associated with each TRP in the two TRPs.

In some embodiments, the indication information indicates frequency hopping patterns of uplink data associated with first TRP in the two TRPs, and the frequency hopping patterns of uplink data associated with the other TRP in the two TRPs are identical to the frequency hopping pattern of the uplink data associated with the first TRP.

In some embodiments, a frequency hopping pattern applied by a transmission occasion in the at least one transmission occasion of the uplink data associated with the first TRP in the two TRPs is identical to a frequency hopping pattern applied by a transmission occasion in the at least one transmission occasion of the uplink data associated with the second TRP in the two TRPs.

In some embodiments, the frequency hopping pattern includes at least one of the following:

whether to perform frequency hopping;

the number of hops;

a starting frequency domain position of frequency hopping; and

a frequency offset of frequency hopping.

In some embodiments, that at least one transmission occasion of the uplink data is associated with two TRPs refers one of the following,

the at least one transmission occasion of the uplink data is respectively associated with the two TRPs in unit of a transmission occasion of at least one nominal repetition of the uplink data;

the at least one transmission occasion of the uplink data is respectively associated with the two TRPs in unit of a transmission occasion of at least one actual repetition of the uplink data; and

the at least one transmission occasion of the uplink data is respectively associated with the two TRPs in unit of at least one slot.

In some embodiments, the TRP is equivalent to at least one of the following:

a transmission configuration indication (TCI) state;

a spatial relation;

a reference signal;

a reference signal group;

an SRS resource group (containing one or more SRS resources);

a spatial domain filter;

a power control parameter; and

a group of time alignment (TA) related parameters.

According to the embodiment of this disclosure, frequency diversity gains may be increased, thereby improving performances of the system.

### Embodiment of an Eighth Aspect

The embodiment of this disclosure provides an apparatus for indicating uplink data transmission. The apparatus may be, for example, a network device, or may be one or more components or assemblies configured in a network device.

FIG. 29 is a schematic diagram of the apparatus for indicating uplink data transmission of an embodiment of this disclosure. As principles of the apparatus for solving problems are similar to the method of the embodiment of the fourth aspect shown in FIG. 24, reference may be made to the implementation of the method of the embodiment of the fourth aspect for specific implementations of the apparatus, with identical contents being not going to be repeated herein any further.

As shown in FIG. 29, the apparatus 2900 for indicating uplink data transmission of the embodiment of this disclosure includes a transmitting unit 2901 configured to transmit indication information to a terminal equipment, the indication information indicating an RV of a transmission occasion of uplink data associated with a first TRP in two TRPs, an RV of at least one transmission occasion of the uplink data being derived according to the two TRPs.

In some embodiments, the above indication information is contained in DCI signaling or RRC signaling.

FIG. 30 is another schematic diagram of the apparatus for indicating uplink data transmission of an embodiment of this disclosure. As principles of the apparatus for solving problems are similar to the method of the embodiment of the fourth aspect shown in FIG. 25, reference may be made to the implementation of the method of the embodiment of the fourth aspect for specific implementations of the apparatus, with identical contents being not going to be repeated herein any further.

As shown in FIG. 30, the apparatus 3000 for indicating uplink data transmission of the embodiment of this disclosure includes a transmitting unit 3001 configured to transmit indication information to a terminal equipment, the indication information indicating a frequency hopping pattern, the terminal equipment transmitting uplink data according to the frequency hopping pattern; wherein at least one transmission occasion of the uplink data is associated with two TRPs, and the terminal equipment performs frequency hopping on transmission of the uplink data according to a transmission occasion in the at least one transmission occasion of the uplink data associated with a TRP in the two TRPs.

It should be noted that the components or modules related to this disclosure are only described above. However, this disclosure is not limited thereto, and the apparatus 2900/3000 for indicating uplink data transmission may further include other components or modules, and reference may be made to related techniques for particulars of these components or modules.

Furthermore, for the sake of simplicity, connection relationships between the components or modules or signal profiles thereof are only illustrated in FIGS. 29 and 30. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

According to the embodiment of this disclosure, frequency diversity gains may be increased, thereby improving performances of the system.

### Embodiment of a Ninth Aspect

The embodiment of this disclosure provides a communication system. FIG. 31 is a schematic diagram of the communication system of the embodiment of this disclosure. As shown in FIG. 31, the communication system 3100 includes a network device 3101 and a terminal equipment 3102. For the sake of simplification, description is given in FIG. 31 by taking only one terminal equipment and one network device as examples; however, the embodiment of this disclosure is not limited thereto.

In the embodiment of this disclosure, existing services or services that may be implemented in the future may be performed between the network device 3101 and the terminal equipment 3102. For example, such services may include but not limited to an enhanced mobile broadband (eMBB), massive machine type communication (mMTC), ultra-reliable and low-latency communication (URLLC), and vehicle to everything communication (V2X), etc.

In some embodiments, the network device 3101 generates indication information and transmits the indication information to the terminal equipment 3102, and the terminal equipment 3102 receives the indication information, and transmits uplink data according to the indication information. Reference may be made to the embodiment of the eighth aspect and the embodiment of the fourth aspect for contents related to the network device 3101, which shall not be described herein any further. And reference may be made to the embodiments of the fifth to the seventh aspects and the embodiments of the first to the third aspects for contents related to the terminal equipment 3102, which shall not be described herein any further.

The embodiment of this disclosure further provides a terminal equipment. The terminal equipment may be, for example, a UE; however, this disclosure is not limited thereto, and it may also be another equipment.

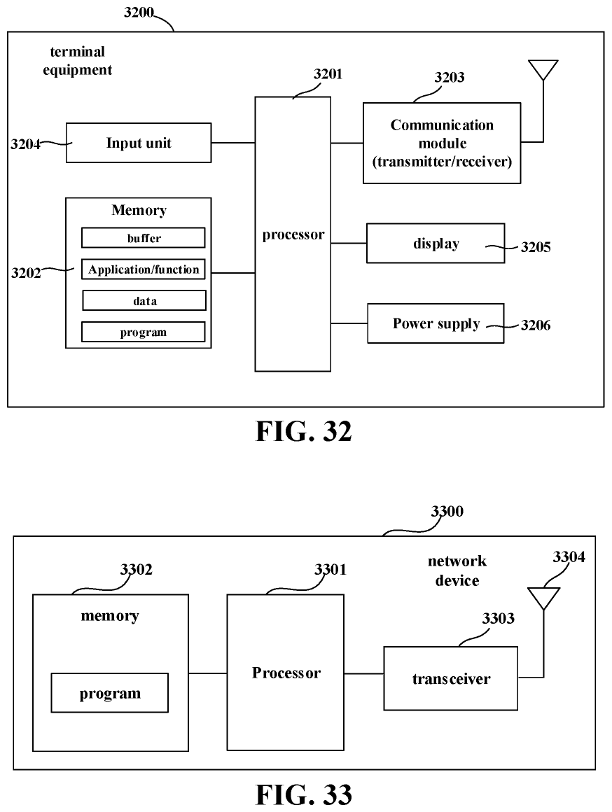

FIG. 32 is a schematic diagram of the terminal equipment of the embodiment of this disclosure. As shown in FIG. 32, the terminal equipment 3200 may include a processor 3201 and a memory 3202, the memory 3202 storing data and a program and being coupled to the processor 3201. It should be noted that this figure is illustrative only, and other types of structures may also be used, so as to supplement or replace this structure and achieve a telecommunications function or other functions.

For example, the processor 3201 may be configured to execute a program to carry out the method for transmitting uplink data as described in the embodiments of the first to the third aspects.

As shown in FIG. 32, the terminal equipment 3200 may further include a communication module 3203, an input unit 3204, a display 3205, and a power supply 3206; wherein functions of the above components are similar to those in the related art, which shall not be described herein any further. It should be noted that the terminal equipment 3200 does not necessarily include all the parts shown in FIG. 32, and the above components are not necessary. Furthermore, the terminal equipment 3200 may include parts not shown in FIG. 32, and the related art may be referred to.

The embodiment of this disclosure further provides a network device, which may be, for example, a gNB. However, this disclosure is not limited thereto, and it may also be another network device.

FIG. 33 is a schematic diagram of a structure of the network device of the embodiment of this disclosure. As shown in FIG. 33, the network device 3300 may include a processor 3301 (such as a central processing unit (CPU)) and a memory 3302, the memory 3302 being coupled to the processor 3301. The memory 3302 may store various data, and furthermore, it may store a program for information processing, and execute the program under control of the processor 3301.

For example, the processor 3310 may be configured to execute a program to carry out the method for indicating uplink data transmission as described in the embodiment of the fourth aspect.

Furthermore, as shown in FIG. 33, the network device 3300 may include a transceiver 3303, and an antenna 3304, etc. Functions of the above components are similar to those in the related art, and shall not be described herein any further. It should be noted that the network device 3300 does not necessarily include all the parts shown in FIG. 33, and furthermore, the network device 3300 may include parts not shown in FIG. 33, and the related art may be referred to.

An embodiment of this disclosure provides a computer readable program, which, when executed in a terminal equipment, will cause a computer to carry out the method as described in the embodiment of the first or the second or the third aspect in the terminal equipment.

An embodiment of this disclosure provides a storage medium storing a computer readable program, which will cause a computer to carry out the method as described in the embodiment of the first or the second or the third aspect in a terminal equipment.

An embodiment of this disclosure provides a computer readable program, which, when executed in a network device, will cause a computer to carry out the method as described in the embodiment of the fourth aspect in the network device.

An embodiment of this disclosure provides a storage medium storing a computer readable program, which will cause a computer to carry out the method as described in the embodiment of the fourth aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations disclosed by the above embodiments, following supplements are further disclosed.

1. A method for transmitting uplink data, wherein the method includes:

transmitting uplink data by a terminal equipment in a manner of PUSCH repetition type B, at least one transmission occasion of the uplink data being associated with two TRPs;

wherein an RV of the at least one transmission occasion of the uplink data is derived according to the two TRPs.

2. The method according to supplement 1, wherein that the RV of the at least one transmission occasion of the uplink data is derived according to the two TRPs refers to that,

an RV of a transmission occasion of an actual repetition in the at least one transmission occasion of the uplink data associated with a first TRP in the two TRPs is derived from a time domain order of the actual repetition,

and an RV of a transmission occasion of an actual repetition in the at least one transmission occasion of the uplink data associated with a second TRP in the two TRPs is derived from the time domain order of the actual repetition.

3. The method according to supplement 1, wherein that the RV of the at least one transmission occasion of the uplink data is derived according to the above two TRPs refers to that,

an RV of the transmission occasion of the nominal repetition in the at least one transmission occasion of the uplink data associated with the first TRP in the above two TRPs is derived from a time domain order of the nominal repetition; and

an RV of the transmission occasion of the nominal repetition in the at least one transmission occasion of the uplink data associated with the second TRP in the above two TRPs is derived from the time domain order of the nominal repetition.

4. The method according to supplement 1, wherein the method further includes:

receiving indication information by the terminal equipment;

wherein the indication information indicates the RV of the transmission occasion of the uplink data associated with the first TRP in the two TRPs,

and the indication information is contained in DCI signaling or RRC signaling.

5. The method according to supplement 1, wherein,

an RV of a first transmission occasion of the uplink data is related to an RV of a second transmission occasion of the uplink data, and wherein,

the first transmission occasion is associated with the first TRP in the two TRPs,

and the second transmission occasion is associated with the second TRP in the two TRPs.

6. The method according to supplement 5, wherein,

a sequence number related to the first transmission occasion is identical to a sequence number related to the second transmission occasion.

7. The method according to supplement 5 or 6, wherein that the RV of the first transmission occasion of the uplink data is related to the RV of the second transmission occasion of the uplink data refers to that,

a difference (offset/shift) between the RV of the first transmission occasion and the RV of the second transmission occasion is indicated by RRC signaling.

8. The method according to supplement 5 or 6, wherein that the RV of the first transmission occasion of the uplink data is related to the RV of the second transmission occasion of the uplink data refers to that,

a difference between the RV of the first transmission occasion and the RV of the second transmission occasion is indicated by DCI signaling.

9. The method according to supplement 5 or 6, wherein that the RV of the first transmission occasion of the uplink data is related to the RV of the second transmission occasion of the uplink data refers to that,

the RV of the first transmission occasion is identical to the RV of the second transmission occasion.

10. The method according to supplement 5 or 6, wherein that the RV of the first transmission occasion of the uplink data is related to the RV of the second transmission occasion of the uplink data refers to that,

a difference between the RV of the first transmission occasion and the RV of the second transmission occasion is determined according to a third transmission occasion;

wherein the third transmission occasion refers to a last transmission occasion before the second transmission occasion associated with the first TRP in the two TRPs.

11. The method according to supplement 1, wherein the uplink data start from the transmission occasion of the actual repetition associated with the first TRP in the two TRPs and with a corresponding RV of 0.

12. The method according to supplement 1, wherein an RV sequence applied by the transmission occasion in the at least one transmission occasion of the uplink data associated with the first TRP in the two TRPs is identical to an RV sequence applied by the transmission occasion in the at least one transmission occasion of the uplink data associated with the second TRP in the two TRPs.

13. The method according to supplement 1, wherein that the at least one transmission occasion of the uplink data is associated with two TRPs refers to one of the following:

the at least one transmission occasion of the uplink data is respectively associated with the two TRPs in unit of a transmission occasion of at least one nominal repetition of the uplink data;

the at least one transmission occasion of the uplink data is respectively associated with the two TRPs in unit of a transmission occasion of at least one actual repetition of the uplink data; and

the at least one transmission occasion of the uplink data is respectively related to the two TRPs in unit of at least one slot.

14. The method according to any one of supplements 1-13, wherein the TRP is equivalent to at least one of the following:

a transmission configuration indication state;

a spatial relation;

a reference signal;

a reference signal group;

an SRS resource group;

a spatial domain filter;

a power control parameter; and

a group of time alignment (TA) related parameters.

15. A method for transmitting uplink data, wherein the method includes:

transmitting uplink data by a terminal equipment in a manner of PUSCH repetition type A, at least one transmission occasion of the uplink data being associated with two TRPs;

wherein an RV of at least one transmission occasion of the uplink data is derived according to the two TRPs.

16. The method according to supplement 15, wherein that the RV of at least one transmission occasion of the uplink data is derived according to the two TRPs refers to that,

an RV of a transmission occasion in the at least one transmission occasion of the uplink data associated with a first TRP in the two TRPs is derived from a time domain order of the transmission occasion associated with the first TRP,

and an RV of a transmission occasion in the at least one transmission occasion of the uplink data associated with a second TRP in the two TRPs is derived from a time domain order of the transmission occasion associated with the second TRP.

17. The method according to supplement 15, wherein the method further includes:

receiving indication information by the terminal equipment;

wherein the indication information indicates the RV of the transmission occasion of the uplink data associated with the first TRP in the two TRPs,

and the indication information is contained in DCI signaling or RRC signaling.

18. The method according to supplement 15, wherein,

an RV of a first transmission occasion of the uplink data is related to an RV of a second transmission occasion of the uplink data, and wherein,

the first transmission occasion is associated with the first TRP in the two TRPs,

and the second transmission occasion is associated with the second TRP in the two TRPs.

19. The method according to supplement 18, wherein,

a sequence number related to the first transmission occasion is identical to a sequence number related to the second transmission occasion.

20. The method according to supplement 18, wherein that an RV of a first transmission occasion of the uplink data is related to an RV of a second transmission occasion of the uplink data refers to that,

a difference between the RV of the first transmission occasion and the RV of the second transmission occasion is indicated by RRC signaling.

21. The method according to supplement 18, wherein that an RV of a first transmission occasion of the uplink data is related to an RV of a second transmission occasion of the uplink data refers to that,

a difference between the RV of the first transmission occasion and the RV of the second transmission occasion is indicated by DCI signaling.

22. The method according to supplement 18, wherein that an RV of a first transmission occasion of the uplink data is related to an RV of a second transmission occasion of the uplink data refers to that, the RV of the first transmission occasion is identical to the RV of the second transmission occasion.

23. The method according to supplement 18, wherein that an RV of a first transmission occasion of the uplink data is related to an RV of a second transmission occasion of the uplink data refers to that,

a difference between the RV of the first transmission occasion and the RV of the second transmission occasion is determined according to a third transmission occasion;

wherein the third transmission occasion refers to a last transmission occasion before the second transmission occasion associated with the first TRP in the two TRPs.

24. The method according to supplement 15, wherein the uplink data start from the transmission occasion associated with the first TRP in the two TRPs and with a corresponding RV of 0.

25. The method according to supplement 15, wherein an RV sequence applied by the transmission occasion in the at least one transmission occasion of the uplink data associated with the first TRP in the two TRPs is identical to an RV sequence applied by the transmission occasion in the at least one transmission occasion of the uplink data associated with the second TRP in the two TRPs.

26. The method according to supplement 15, wherein that the at least one transmission occasion of the uplink data is associated with two TRPs refers to one of the following:

the at least one transmission occasion of the uplink data is respectively associated with the two TRPs in unit of at least one slot; and

the at least one transmission occasion of the uplink data is respectively associated with the two TRPs in unit of at least one time domain portion in a slot.

27. The method according to any one of supplements 15-26, wherein the TRP is equivalent to at least one of the following:

a transmission configuration indication state;

a spatial relation;

a reference signal;

a reference signal group;

an SRS resource group;

a spatial domain filter;

a power control parameter; and

a group of time alignment (TA) related parameters.

28. A method for transmitting uplink data, wherein the method includes:

transmitting uplink data by a terminal equipment, at least one transmission occasion of the uplink data being associated with two TRPs, and

performing frequency hopping on transmission of the uplink data by the terminal equipment according to a transmission occasion in the at least one transmission occasion of the uplink data associated with a TRP in the two TRPs.

29. The method according to supplement 28, wherein that the transmission occasion in the at least one transmission occasion of the uplink data associated with a TRP in the two TRPs refers to one of the following:

a transmission occasion of a nominal repetition in the at least one transmission occasion of the uplink data associated with a TRP in the two TRPs, wherein the uplink data are transmitted in a manner of PUSCH repetition type B;

a transmission occasion of an actual repetition in the at least one transmission occasion of the uplink data associated with a TRP in the two TRPs, wherein the uplink data are transmitted in a manner of PUSCH repetition type B; and

a transmission occasion in the at least one transmission occasion of the uplink data in at least one slot associated with a TRP in the two TRPs, wherein the uplink data are transmitted in a manner of PUSCH repetition type A.

30. The method according to supplement 28 or 29, wherein the performing frequency hopping refers to performing frequency hopping according to the nominal repetition of the uplink data.

31. The method according to supplement 28 or 29, wherein the performing frequency hopping refers to performing frequency hopping according to the actual repetition of the uplink data.

32. The method according to supplement 28 or 29, wherein the performing frequency hopping refers to performing frequency hopping according to a slot where the uplink data are located.

33. The method according to supplement 28 or 29, wherein the performing frequency hopping refers to performing frequency hopping according to a time domain portion corresponding to the uplink data, in a slot where the uplink data are located.

34. The method according to supplement 28, wherein the method further includes:

receiving indication information by the terminal equipment, the indication information indicating a frequency hopping pattern and being contained in RRC signaling.

35. The method according to supplement 34, wherein,

the indication information indicates the frequency hopping pattern of the uplink data associated with each of the two TRPs; or

the indication information indicates the frequency hopping pattern of the uplink data associated with the first TRP in the two TRPs, and the frequency hopping patterns of the uplink data associated with the other TRP in the two TRPs are identical to the frequency hopping pattern of the uplink data associated with the first TRP.

36. The method according to supplement 28, wherein a frequency hopping pattern applied by a transmission occasion in the at least one transmission occasion of the uplink data associated with a first TRP in the two TRPs is identical to a frequency hopping pattern applied by a transmission occasion in the at least one transmission occasion of the uplink data associated with a second TRP in the two TRPs.

37. The method according to any one of supplements 34-36, wherein the frequency hopping pattern includes at least one of the following:

whether to perform frequency hopping;

the number of hops;

a starting frequency domain position of frequency hopping; and

a frequency offset of frequency hopping.

38. The method according to supplement 28, wherein that the at least one transmission occasion of the uplink data is associated with two TRPs refers to that,

the at least one transmission occasion of the uplink data is respectively associated with the two TRPs in unit of a transmission occasion of at least one nominal repetition of the uplink data;

the at least one transmission occasion of the uplink data is respectively associated with the two TRPs in unit of a transmission occasion of at least one actual repetition of the uplink data;

the at least one transmission occasion of the uplink data is respectively associated with the two TRPs in unit of at least one slot.

39. The method according to any one of supplements 28-38, wherein the TRP is equivalent to at least one of the following:

a transmission configuration indication state;

a spatial relation;

a reference signal;

a reference signal group;

an SRS resource group;

a spatial domain filter;

a power control parameter; and

a group of time alignment (TA) related parameters.

40. A method for indicating uplink data transmission, wherein the method includes:

transmitting indication information by a network device to a terminal equipment, the indication information indicating an RV of a transmission occasion of uplink data associated with a first TRP in two TRPs, an RV of at least one transmission occasion of the uplink data being derived according to the two TRPs.

41. The method according to supplement 40, wherein the indication information is contained in DCI signaling or RRC signaling.

42. A method for indicating uplink data transmission, wherein the method includes:

transmitting indication information by a network device to a terminal equipment, the indication information indicating a frequency hopping pattern, and the terminal equipment transmitting uplink data according to the frequency hopping pattern;

wherein at least one transmission occasion of the uplink data is associated with two TRPs, and the terminal equipment performs frequency hopping on transmission of the uplink data according to a transmission occasion of at least one transmission occasion of the uplink data associated with a TRP in the two TRPs.

43. A terminal equipment, including a memory and a processor, the memory storing a computer program, and the processor being configured to execute the computer program to carry out the method as described in any one of supplements 1-39.

44. A network device, including a memory and a processor, the memory storing a computer program, and the processor being configured to execute the computer program to carry out the method as described in any one of supplements 40-42.

45. A communication system, including a terminal equipment and a network device, wherein,

the terminal equipment is configured to carry out the method as described in any one of supplements 1-27, and the network device is configured to carry out the method as described in either one of supplements 40 and 41; or

the terminal equipment is configured to carry out the method as described in any one of supplements 28-39, and the network device is configured to carry out the method as described in supplement 42.

What is claimed is:

1. An apparatus for transmitting uplink data, wherein the apparatus comprises:
a transmitter configured to transmit uplink data in a manner of PUSCH repetition type B, more than one actual repetition of the uplink data being associated with two TRPs;
wherein a redundancy version (RV) of the more than one actual repetition of the uplink data is derived according to the two TRPs.

2. The apparatus according to claim 1, wherein the RV of the more than one actual repetition of the uplink data is derived according to the two TRPs refers to that,
an RV of an actual repetition in the more than one actual repetition of the uplink data associated with a first TRP in the two TRPs is derived from a time domain order of the more than one actual repetition associated with the first TRP, and
an RV of an actual repetition in the more than one actual repetition of the uplink data associated with a second TRP in the two TRPs is derived from a time domain order of the more than one actual repetition associated with the second TRP.

3. The apparatus according to claim 1, wherein the apparatus further comprises:
a receiver configured to receive indication information;
wherein the indication information indicates the RV of the actual repetition of the uplink data associated with the first TRP in the two TRPs,
and the indication information is contained in DCI signaling or RRC signaling.

4. The apparatus according to claim 1, wherein,
an RV of a first actual repetition of the uplink data is related to an RV of a second actual repetition of the uplink data, wherein,
the first actual repetition is associated with the first TRP in the two TRPs,
and the second actual repetition is associated with the second TRP in the two TRPs.

5. The apparatus according to claim 4, wherein,
a sequence number related to the first actual repetition is identical to a sequence number related to the second actual repetition.

6. The apparatus according to claim 1, wherein an RV sequence applied by the actual repetition in the more than one actual repetition of the uplink data associated with the first TRP in the two TRPs is identical to an RV sequence applied by the actual repetition in the more than one actual repetition of the uplink data associated with the second TRP in the two TRPs.

7. The apparatus according to claim 1, wherein the TRP is equivalent to at least one of the following:
a transmission configuration indication state;
a spatial relation;
a reference signal;
a reference signal group;
an SRS resource group;
a spatial domain filter;
a power control parameter; and
a group of time alignment (TA) related parameters.

8. The apparatus according to claim 4, wherein that an RV of a first actual repetition of the uplink data is related to an RV of a second actual repetition of the uplink data refers to that,
an offset between the RV of the first actual repetition of the uplink data and the RV of the second actual repetition of the uplink data is configured by RRC signaling.

9. An apparatus for transmitting uplink data, wherein the apparatus comprises:
a transmitter configured to transmit uplink data in a manner of PUSCH repetition type A, more than one transmission occasion of the uplink data being associated with two TRPs;
wherein an RV of the more than one transmission occasion of the uplink data is derived according to the two TRPs.

10. The apparatus according to claim 9, wherein the RV of the more than one transmission occasion of the uplink data is derived according to the two TRPs refers to that,
an RV of a transmission occasion in the more than one transmission occasion of the uplink data associated with a first TRP in the two TRPs is derived from a time domain order of the more than one transmission occasion associated with the first TRP,
and an RV of a transmission occasion in the more than one transmission occasion of the uplink data associated with a second TRP in the two TRPs is derived from a time domain order of the more than one transmission occasion associated with the second TRP.

11. The apparatus according to claim 9, wherein the apparatus further comprises:
a receiver configured to receive indication information;
wherein the indication information indicates the RV of the transmission occasion of the uplink data associated with the first TRP in the two TRPs,
and the indication information is contained in DCI signaling or RRC signaling.

12. The apparatus according to claim 9, wherein,
an RV of a first transmission occasion of the uplink data is related to an RV of a second transmission occasion of the uplink data, and wherein,
the first transmission occasion is associated with the first TRP in the two TRPs,
and the second transmission occasion is associated with the second TRP in the two TRPs.

13. The apparatus according to claim 12, wherein,
a sequence number related to the first transmission occasion is identical to a sequence number related to the second transmission occasion.

14. The apparatus according to claim 12, wherein that an RV of a first transmission occasion of the uplink data is related to an RV of a second transmission occasion of the uplink data refers to that,
the RV of the first transmission occasion is identical to the RV of the second transmission occasion.

15. The apparatus according to claim 9, wherein the TRP is equivalent to at least one of the following:
a transmission configuration indication state;
a spatial relation;
a reference signal;
a set of reference signal;
an SRS resource group;
a spatial domain filter;
a power control parameter; and
a group of time alignment (TA) related parameters.

16. The apparatus according to claim 12, wherein that an RV of a first transmission occasion of the uplink data is related to an RV of a second transmission occasion of the uplink data refers to that,
an offset between the RV of the first transmission occasion of the uplink data and the RV of the second transmission occasion of the uplink data is configured by RRC signaling.

17. An apparatus for transmitting uplink data, wherein the apparatus comprises:
a transmitter configured to transmit uplink data in a manner of PUSCH repetition type B, more than one nominal repetition of the uplink data being associated with at least two TRPs, wherein
the transmitter performs frequency hopping in a manner of inter-slot frequency hopping.
